(19) United States
(12) Patent Application Publication
(10) Pub. No.: US 2026/0353062 A1
(43) Pub. Date: Nov. 5, 2026

(54) COMMUNICATION RECORD MANAGEMENT SERVER, COMMUNICATION RECORD MANAGEMENT METHOD, AND STORAGE MEDIUM

(71) Applicants: SUMITOMO ELECTRIC INDUSTRIES, LTD., Osaka-shi, Osaka (JP); SUMITOMO WIRING SYSTEMS, LTD., Yokkaichi-shi, Mie (JP); AUTONETWORKS TECHNOLOGIES, LTD., Yokkaichi-shi, Mie (JP)

(72) Inventor: Michikazu UMEMURA, Osaka-shi (JP)

(73) Assignees: SUMITOMO ELECTRIC INDUSTRIES, LTD., Osaka-shi, Osaka (JP); SUMITOMO WIRING SYSTEMS, LTD., Yokkaichi-shi, Mie (JP); AUTONETWORKS TECHNOLOGIES, LTD., Yokkaichi-shi, Mie (JP)

(21) Appl. No.: 19/121,317

(22) PCT Filed: Aug. 24, 2023
(86) PCT No.: PCT/JP2023/030441

§ 371 Date: Apr. 15, 2025

(30) Foreign Application Priority Data
Oct. 18, 2022 (JP) 2022-166644

(51) Int. Cl. H04W 8/18; H04W 8/20; H04W 28/02; H04W 64/00

(52) U.S. Cl. CPC H04W 8/183; H04W 8/20; H04W 28/0236; H04W 64/00

(57) ABSTRACT

A communication history management server including: a processor that is configured to: receive communication history information including at least position information, date and time information, and communication quality metrics information related to at least communication quality of wireless communication at a position specified by the position information and at a date and time specified by the date and time information; accumulate in a memory the communication history information that is received; and in response to receiving a transmission request to transmit the communication history information with a regional range designated from an external device, generate information related to communication history including the position information corresponding to an inside of the regional range designated by the transmission request and communication quality information obtained from the communication quality metrics information, based on the communication history information accumulated in the memory, and transmit the generated information to the external device.

### BACKGROUND

This disclosure relates to a communication history management server, a communication history management method, and a storage medium. This application claims priority based on Japanese Application No. 2022-166644, filed Oct. 18, 2022, and incorporates all the contents described in the Japanese application by reference.

An increasing number of in-vehicle devices have functions of receiving various services provided by external servers and transmitting information acquired by in-vehicle sensors to external servers via wireless communication. A vehicle equipped with such an in-vehicle device is called a connected car.

Communication quality is an issue when a connected car uses a service that relies on wireless communication. If the communication quality is degraded or the vehicle is out of the communication range, the vehicle cannot continue to use the service.

JP 2021-135099A below discloses a proposal to solve such a problem. The technology disclosed in JP 2021-135099A aims to provide visual notification of a communication environment. The technology disclosed in JP 2021-135099A acquires an electric field strength map indicating predetermined electric field strength, and displays the electric field strength map superimposed on graphics indicating a traveling position of the vehicle based on road map data and the vehicle position.

### SUMMARY

A communication history management server according to an aspect of this disclosure includes: a communication history information receiving unit for receiving communication history information including at least position information, date and time information, and communication quality metrics information related to at least communication quality of wireless communication at a position specified by the position information and at a date and time specified by the date and time information; a communication history information storage unit for accumulating the communication history information received by the communication history information receiving unit; and a communication history transmission unit that, in response to receiving a transmission request to transmit the communication history information with a regional range designated from an external device, generates information related to communication history including the position information corresponding to an inside of the regional range designated by the transmission request and communication quality information obtained from the communication quality metrics information, based on the communication history information accumulated in the communication history information storage unit, and transmits the generated information to the external device.

The above and other objects, features, aspects, and advantages of the disclosure will become apparent from the following detailed description of this disclosure, which will be understood in conjunction with the accompanying drawings.

### BRIEF DESCRIPTION OF THE DRAWINGS

FIG. 1 is a diagram showing a route suggestion screen of an in-vehicle device according to a first embodiment.

FIG. 2 is a block diagram showing an overall configuration of a vehicle assistance system according to the first embodiment.

FIG. 3 is a block diagram showing a configuration of the in-vehicle device according to the first embodiment.

FIG. 4 is a block diagram showing a configuration of a communication history management server according to the first embodiment.

FIG. 5 is a diagram showing a record configuration of a communication history information DB (Database) according to the first embodiment.

FIG. 6 is a flowchart showing a control structure of a computer program that implements a communication history recording unit according to the first embodiment.

FIG. 7 is a flowchart showing a control structure of a computer program that implements a driving unit according to the first embodiment.

FIG. 8 is a flowchart showing a control structure of a computer program that implements a route calculation unit according to the first embodiment.

FIG. 9 is a flowchart showing a control structure of a computer program that implements a grid rendering unit according to the first embodiment.

FIG. 10 is a block diagram showing a configuration of a vehicle assistance system according to a second embodiment.

FIG. 11 is a block diagram showing a configuration of an in-vehicle device according to the second embodiment.

FIG. 12 is a block diagram showing a configuration of a communication history management server according to the second embodiment.

FIG. 13 is a block diagram showing a configuration of a vehicle assistance system according to a third embodiment.

FIG. 14 is a block diagram showing a configuration of an in-vehicle device according to the third embodiment.

FIG. 15 is a flowchart showing a control structure of a computer program that implements a communication history comparison unit according to the third embodiment.

FIG. 16 is a block diagram showing a configuration of a vehicle assistance system according to a fourth embodiment.

FIG. 17 is a block diagram showing a configuration of an in-vehicle device according to the fourth embodiment.

FIG. 18 is a block diagram showing a configuration of a communication history management server according to the fourth embodiment.

FIG. 19 is a diagram showing a record configuration of a communication history statistics information DB (Database) according to the fourth embodiment.

FIG. 20 is a flowchart showing a control structure of a computer program that implements a communication statistics calculation unit in the communication history management server according to the fourth embodiment.

FIG. 21 is a flowchart showing a control structure of a computer program that implements a communication history transmission unit in the communication history management server according to the fourth embodiment.

FIG. 22 is a block diagram showing a functional configuration of a communication history management server according to a variation of the fourth embodiment.

FIG. 23 is a diagram showing a display performed in a vehicle assistance system according to a fifth embodiment.

FIG. 24 is a flowchart showing a control structure of a computer program for creating a display in the vehicle assistance system according to the fifth embodiment.

FIG. 25 is a flowchart showing a control structure of a computer program that implements a display of a travel route.

FIG. 26 is a block diagram showing a configuration of steps that implements the in-vehicle device according to each of the embodiments of this disclosure.

FIG. 27 is a diagram showing an appearance of a computer system that implements each of the driving support servers according to this disclosure.

FIG. 28 is a diagram showing a hardware configuration of the computer system shown in FIG. 27.

### DETAILED DESCRIPTION OF EMBODIMENTS

### Technical Problem

It is not only electric field strength that is important for a connected car to receive adequate service. Due to a large number of in-vehicle sensors and an increasing amount of data thereof, the communication speed is also important when the connected car transmits sensor data to an external server or downloads data for driving assistance from an external server. Furthermore, latency is also important when communicating data related to vehicle safety.

In the technology disclosed in JP 2021-135099A above, an electric field strength map is displayed superimposed on a map. It can be understood that the communication speed decreases at a location where the electric field strength is low. However, even if the electric field strength is high, the communication speed does not necessarily increase. Even if the electric field strength is high, it is possible that the communication speed decreases or the latency increases depending on the circumstances. Even a slight change in the environment can cause a sudden deterioration in communication speed. The position of the vehicle and the surrounding circumstances change from time to time. Thus, even if the electric field strength map is obtained, it is difficult to predict how the communication speed, latency, and the like actually change, and communication quality sufficient to use services cannot always be obtained while the connected car is traveling. That is, the technology disclosed in JP 2021-135099A is not considered to be sufficient to be applied to a connected car.

In view of this, an object of this disclosure is to provide a communication history management server, a communication history management method, and a computer program that provide information with which a travel route can be easily determined while considering communication quality.

### Advantageous Effects of Disclosure

As described above, according to this disclosure, it is possible to provide a communication history management server, a communication history management method, and a computer program that provide information with which a travel route can be easily determined while considering communication quality.

### DESCRIPTION OF EMBODIMENTS OF THE PRESENT DISCLOSURE

In the following description and the drawings, the same components are assigned the same reference numbers. Accordingly, the detailed description thereof is not repeated.

Main embodiments illustrated by this disclosure are listed below. Note that one or more of the following embodiments may be combined in any manner.
(1) A communication history management server according to a first aspect of this disclosure includes: a communication history information receiving unit for receiving communication history information including at least position information, date and time information, and communication quality metrics information related to at least communication quality of wireless communication at a position specified by the position information and at a date and time specified by the date and time information; a communication history information storage unit for accumulating the communication history information received by the communication history information receiving unit; and a communication history transmission unit that, in response to receiving a transmission request to transmit the communication history information with a regional range designated from an external device, generates information related to communication history including the position information corresponding to an inside of the regional range designated by the transmission request and communication quality information obtained from the communication quality metrics information, based on the communication history information accumulated in the communication history information storage unit, and transmits the generated information to the external device.

The communication history information storage unit of the communication history management server accumulates communication quality metrics information regarding actual communication performed by a plurality of devices, together with the position information and the date and time information. The communication history transmission unit generates information related to communication history including the communication quality information and transmits the generated information to the external device in response to a request from the external device. The external device can use the communication quality information based on the actual communication history of other devices to estimate and use communication quality at a specific position. As a result, the external device can easily determine a travel route while considering the communication quality.
(2) In (1) above, the communication history transmission unit may include a most recent communication history transmission unit that reads the communication history information from the communication history information storage unit and transmits the read communication history information to the external device, the communication history information read by the most recent communication history transmission unit including: the position information corresponding to an inside of the regional range designated by the transmission request; the date and time information within a most recent predetermined time; and the communication quality metrics information.

The most-recent communication history transmission unit transmits, to the external device, communication history information within the most recent predetermined time, within the regional range designated by the transmission request. As a result, the external device can easily determine a travel route while considering the communication quality that is highly accurate at the present point in time.
(3) In (1) or (2) above, each piece of the communication history information may further include communication environment information related to a communication environment when wireless communication related to the piece of the communication history information is performed, the transmission request may further include information related to a communication environment of the external device, and the communication history transmission unit may include a per-device communication history transmission unit that, in response to receiving the transmission request, reads the communication history information from the communication history information storage unit and transmits the read communication history information to the external device, the communication history information read by the per-device communication history transmission unit including: the position information corresponding to an inside of the regional range designated by the transmission request; the communication environment information matching the information related to the communication environment included in the transmission request; and the communication quality metrics information.

Due to the external device including the information related to the communication environment of the external device in the transmission request, it is possible to obtain communication history information per region and per date and time related to that communication environment. As a result, the external device can easily determine a travel route while considering the communication quality of a wireless communication device to be used.
(4) In (3) above, the communication environment information may include communication line information, telecommunications carrier information, or a combination thereof.

Due to the external device including the information related to the communication line or the telecommunications carrier used thereby in the transmission request, it is possible to obtain the communication history information per region and per date and time related to that communication line or telecommunications carrier. As a result, the external device can easily determine a travel route while considering highly reliable communication quality provided by a wireless communication device to be used.
(5) In (1) above, the communication history management server may further include: a communication statistics calculation unit that calculates communication history statistics information by performing statistics processing related to the communication quality metrics information on the communication history information stored in the communication history information storage unit, based at least on the position specified by the position information; and a communication history statistics information storage unit that stores the communication history statistics information calculated by the communication statistics calculation unit, in association with the position information, wherein the communication history transmission unit may include a communication history statistics information transmission unit that, in response to receiving a transmission request to transmit the communication history information with a regional range designated from an external device, transmits, to the external device, the position information corresponding to an inside of the regional range designated by the transmission request and the communication history statistics information regarding a position specified by the position information, out of the communication history statistics information stored in the communication history statistics information storage unit.

Due to the external device including communication device information related to a wireless communication device that the external device has in the transmission request, it is possible to obtain the communication history information per region and per date and time related to communication performed by other devices having that wireless communication device. As a result, the external device can easily determine a travel route while considering the communication quality of the wireless communication device to be used.
(6) In (5) above, the communication statistics calculation unit may include a per-period communication statistics calculation unit that calculates per-period communication history statistics information by performing statistics processing related to the communication quality metrics information on the communication history information stored in the communication history information storage unit, based at least on the position specified by the position information and a period specified by the date and time information.

Due to the external device including the communication device information related to a wireless communication device that the external device has in the transmission request, it is possible to obtain the communication history information per region and per date and time regarding the external device using that wireless communication device. As a result, the external device can easily determine a travel route while considering the communication quality of the wireless communication device to be used.
(7) In (6) above, each piece of the communication history information may further include information related to a communication environment when wireless communication related to the piece of the communication history information is performed, the transmission request can include information related to the communication environment of the external device, the communication history transmission unit may selectively execute first processing and second processing in accordance with whether or not the received transmission request includes the information related to the communication environment, the first processing may be processing for reading, from the communication history statistics information storage unit, the communication history statistics information matching the position information corresponding to an inside of the regional range designated by the transmission request and the information related to the communication environment included in the transmission request, calculating the communication quality metrics information based on the read communication history statistics information, and transmitting the calculated communication quality metrics information to the external device, and the second processing may be processing for reading the communication history information corresponding to the position information corresponding to an inside of the regional range designated by the transmission request from the communication history information storage unit and transmitting the read communication history information to the external device.

This can increase the accuracy of the communication quality metrics information to be transmitted to the in-vehicle device while preventing an increase in the load of statistics processing.
(8) A communication history management method according to a second aspect of this disclosure includes: a step of receiving communication history information including at least position information, date and time information, and communication quality metrics information related to at least communication quality of wireless communication at a position specified by the position information and at a date and time specified by the date and time information, with use of a computer; a step of accumulating, in a storage device, the communication history information received in the step of receiving the communication history information, with use of the computer; and a step of, in response to receiving a transmission request to transmit the communication history information with a regional range designated from an external device, generating information related to communication history including the position information corresponding to an inside of the regional range designated by the transmission request and communication quality information obtained from the communication quality metrics information, based on the communication history information accumulated in the storage device, and transmitting the generated information to the external device, with use of the computer.

With this communication history management method, the computer accumulates the communication history in actual communication performed by a plurality of devices, together with the position information and the date and time information. The computer further generates information related to communication history including the communication quality information and transmits the generated information to the external device in response to a request from the external device. The external device can use the communication quality information based on the actual communication history of other devices to estimate and use communication quality at a specific position. As a result, the external device can easily determine a travel route while considering the communication quality.
(9) A computer program according to a third aspect of this disclosure causes a computer to execute: a step of receiving communication history information including at least position information, date and time information, and communication quality metrics information related to at least communication quality of wireless communication at a position specified by the position information and at a date and time specified by the date and time information; a step of accumulating, in a storage device, the communication history information received in the step of receiving the communication history information; and a step of, in response to receiving a transmission request to transmit the communication history information with a regional range designated from an external device, generating information related to communication history including the position information corresponding to an inside of the regional range designated by the transmission request and communication quality information obtained from the communication quality metrics information, based on the communication history information accumulated in the storage device, and transmitting the generated information to the external device.

By executing this computer program, the computer accumulates the communication history in actual communication performed by a plurality of devices, together with the position information and the date and time information. The computer further generates information related to communication history including the communication quality information and transmits the generated information to the external device in response to a request from the external device. The external device can use the communication quality information based on the actual communication history of other devices to estimate and use communication quality at a specific position. As a result, the external device can easily determine a travel route while considering the communication quality.

### DETAILS OF EMBODIMENTS OF THE PRESENT DISCLOSURE

Specific examples of a route suggestion screen according to an embodiment of the present disclosure are described below with reference to the drawings. Note that the present disclosure is not limited to these examples but is defined by the claims, and is intended to include all changes made within the meaning and scope equivalent to the claims.

### 1. FIRST EMBODIMENT

### A. Configuration

### A1) Route Suggestion Screen 50

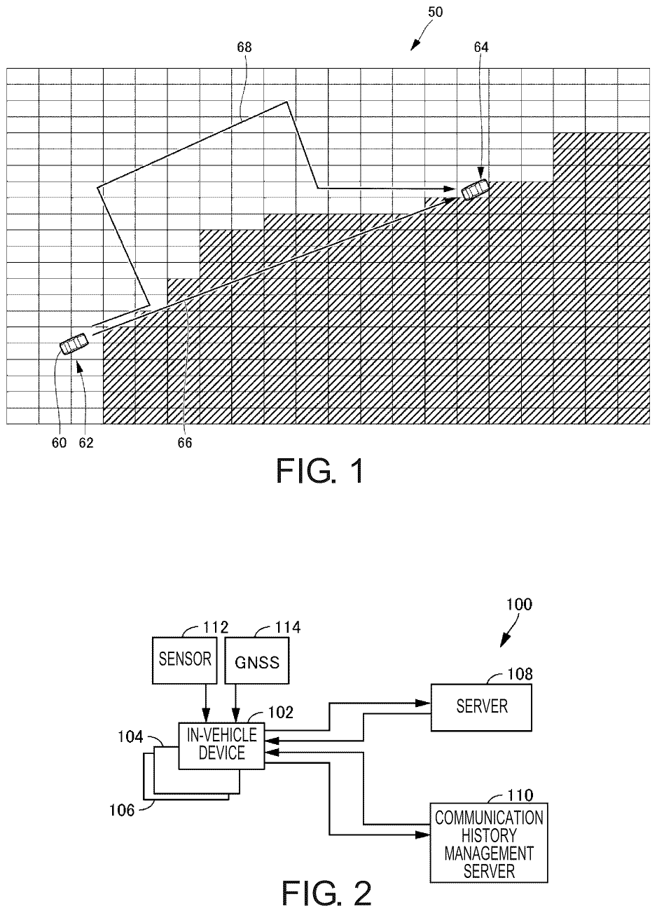

Referring to FIG. 1, a route suggestion screen 50 in a vehicle assistance system according to the first embodiment is a screen displayed on a touchscreen display device of an in-vehicle device. The route suggestion screen 50 is for suggesting to a user a first route 66 and a second route 68 from a current position 62 of a vehicle 60 to a destination 64, which are calculated under different constraints related to communication quality on the routes. The entire route suggestion screen 50 is rectangular. This rectangular area is divided into oblong blocks of the same size to form a grid. In this embodiment, each block is color-coded based on the communication quality actually measured by a vehicle when this vehicle is present in that block, and is displayed superimposed on a map together with the first route 66 and the second route 68. In order to simplify the drawing, the map is not shown in FIG. 1.

In FIG. 1, an unhatched block indicates that the communication quality is relatively good and sufficient for the vehicle 60 to receive a service to be used. A hatched block indicates that communication quality is poorer than that and insufficient for the vehicle 60 to receive the service to be used. In this example, it is assumed that a hatched area is displayed using red color, and an unhatched area is displayed transparent.

In FIG. 1, the blocks are classified into two ways to facilitate understanding of the display related to communication quality. However, this disclosure is not limited to such an embodiment. The communication quality may be divided into three or more stages and displayed separately. Typically, for example, a block with poor communication quality is displayed with a red hue with the lowest brightness. The better the communication quality is, the higher the brightness of the block is, and if the communication quality is higher than or equal to a certain level, the block is displayed colorlessly (transparent) or in a color other than red (e.g., blue). Needless to say, there are various other possible methods to display the blocks. The saturation may be changed without changing the brightness. Further, the hue and either the brightness or the saturation may be changed.

For example, the brightness may usually be changed with a positive correlation to the value of communication quality. In the case of saturation, conversely, it is conceivable to change the saturation with a negative correlation to the value of communication quality. In short, the display mode of each block need only be changed as a monotonic function of the communication quality in that block. In the case of hue, a monotonic function may be used that associates a gradual change from blue to green to red with the level of communication quality.

Further, in FIG. 1, the first route 66 and the second route 68 are displayed as examples. The first route 66 is calculated, for example, as a route for the vehicle 60 to reach the destination 64 from the current position 62 in the shortest time without placing any constraints on communication quality. The second route 68 is also a route for the vehicle 60 to reach the destination 64 from the current position 62. However, the second route 68 is calculated with a constraint on the communication quality, that is, as a route where the communication quality required for the vehicle 60 to use a specific service can be obtained.

Constraints on the communication quality are not limited to those mentioned above, but may be set in various manners by the user of the vehicle 60.

### A2) Vehicle Assistance System 100

Referring to FIG. 2, a vehicle assistance system 100 according to the first embodiment of this disclosure includes: a plurality of in-vehicle devices 102, 104, 106, and so on, which are installed in different vehicles; a server 108 for providing some services to these in-vehicle devices via communication and, conversely, receiving sensor data from the in-vehicle devices and analyzing the traffic situation; and a communication history management server 110 for performing management to accumulate information related to the actual communication quality in each block in an area such as that shown in FIG. 1 and distribute the information to each in-vehicle device, via communication with a plurality of in-vehicle devices such as the in-vehicle device 102.

The in-vehicle devices such as the in-vehicle device 102 are installed in vehicles. Thus, they each have a wireless communication unit, as will be described later. As a medium for wireless communication, a mobile phone line can be used. It is also expected to use Wi-Fi communication depending on the place. In any case, the in-vehicle device 102 and the like can communicate with the server 108 and the communication history management server 110 via wireless communication with a base station and communication using a wired network between the base station and the server 108 and between the base station and the communication history management server 110.

### A3) In-Vehicle Device 102

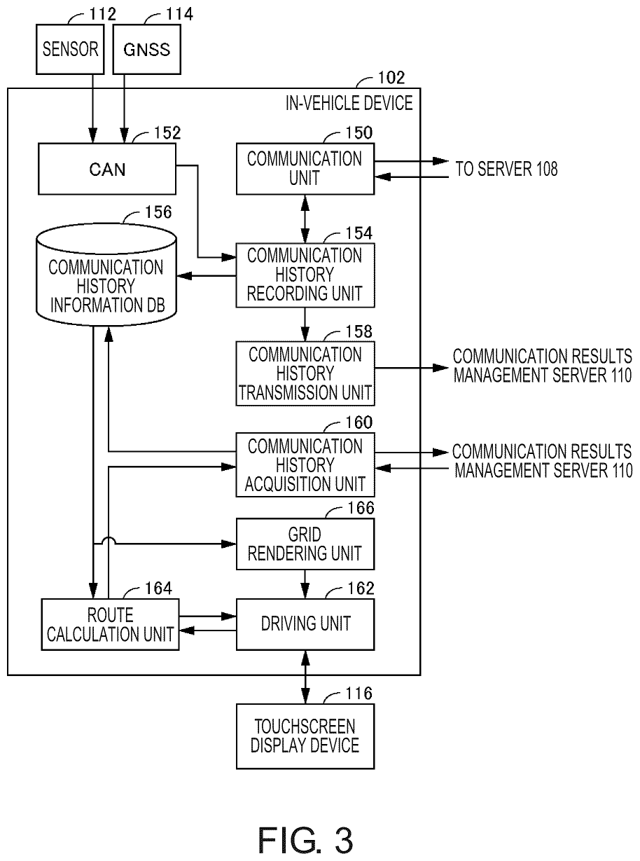

Referring to FIG. 3, the in-vehicle device 102 includes: a communication unit 150 for communicating with an external device such as the server 108 via a wireless communication device (not shown); a communication history recording unit 154 connected to the communication unit 150; a CAN (Controller Area Network) 152 connected to a sensor 112, a GNSS (Global Navigation Satellite System) receiver 114, and the communication history recording unit 154; and a communication history information DB 156 connected to the communication history recording unit 154. The communication unit 150 also receives data for services provided by the server 108 and transmits the received data to a service execution unit, such as an ECU (Electronic Control Unit; not shown), via the CAN 152. Note that in this embodiment, the CAN is used to acquire GNSS information and sensor information. However, this disclosure is not limited to such an embodiment. For example, CAN FD (CAN with Flexible Data rate), CAN XL, Most (Media Oriented Systems Transport), FlexRay, in-vehicle Ethernet (“Ethernet” is a registered trademark), or the like may alternatively be used.

The communication history recording unit 154 periodically measures the communication quality when the communication unit 150 performs communication, and records the communication quality including an actual bit rate (communication speed). Even when the communication unit 150 does not perform communication, radio field strength information can be acquired, so this information is recorded.

The communication history recording unit 154 receives sensor data from the GNSS receiver 114 and various other sensors 112 installed in the vehicle via the CAN 152, and records a communication history record combining a vehicle state, position information, and the like that are obtained from the received information, in the communication history information DB 156.

The in-vehicle device 102 further includes: a communication history transmission unit 158 connected to the communication history recording unit 154; a communication history acquisition unit 160 connected to the communication history information DB 156; a driving unit 162 connected to the touchscreen display device 116; a route calculation unit 164 connected to the communication history information DB 156, the driving unit 162, and the communication history acquisition unit 160; and a grid rendering unit 166.

The communication history transmission unit 158 transmits communication history information on the communication unit 150 recorded by the communication history recording unit 154 to the communication history management server 110 according to a predetermined transmission schedule. The communication history acquisition unit 160 transmits a transmission request, namely a request to transmit communication history information, to the communication history management server 110 when necessary, thereby acquiring communication history information regarding other vehicles from the communication history management server 110 and updating (adding the information to) the communication history information DB 156. The transmission request here includes information specifying a target area, and may also include necessary date and time information or the communication environment in some cases. The term “communication environment” as used herein includes a communication line or telecommunications carrier used in communication, or a combination thereof. The driving unit 162 is a device for performing automatic driving or remote driving in addition to a common, so-called in-vehicle navigation function, and receives input of information for route suggestion (information related to a destination of a travel route and the like) by interaction with the user using the touchscreen display device 116. Note that the communication history acquisition unit 160 may also receive the communication history information from the communication history management server 110 in accordance with a predetermined schedule.

At this time, the driving unit 162 may have the user input constraint conditions for generating a travel route. The constraint conditions include, for example, the number of travel routes to be generated, information specifying a service to be used in the travel routes, conditions to be satisfied by the travel routes, and the like. In the following embodiments, it is assumed that the user designates three as the number of travel routes to be generated. These three travel routes are, for example, the following first to third shortest routes. The first shortest route is the shortest route connecting the current position and the destination regardless of the communication speed. The second shortest route is the shortest route out of travel routes along which the communication speed that allows the service to be available is expected over the entire route. The third shortest route is a travel route along which the service may not be available at a sufficient bit rate at some point, but a bit rate required for another alternative service or the same service as that is expected to be ensured at a communication speed that is half or higher a designated bit rate.

The route calculation unit 164 requests the communication history acquisition unit 160 to acquire information such as communication history and required position and time from the communication history information DB 156 based on the user input received by the driving unit 162 and communication conditions required to use the service. The route calculation unit 164 calculates a plurality of travel routes under a plurality of types of constraints based on the communication history information acquired by the communication history acquisition unit 160 from the communication history information DB 156, destination information, and required communication conditions, and displays the calculated travel routes on the touchscreen display device 116 via the driving unit 162. The grid rendering unit 166 in this embodiment displays information indicating communication history in each part of the displayed region, superimposed on candidate travel routes and the map displayed on the touchscreen display device 116. Note that the communication history information is information combining the communication history (communication speed or radio field strength) with information indicating the state of the vehicle (speed, traveling direction, or the like of the vehicle) when the communication history was acquired.

More specifically, the grid rendering unit 166 divides the displayed area into blocks, and displays each block with an adjusted color, brightness, or saturation as a function of an index value representing the past communication history (communication quality) in the block, superimposed on the candidate travel routes and the map. The past communication history is obtained from the information accumulated in the communication history information DB 156.

### A4) Communication History Management Server 110

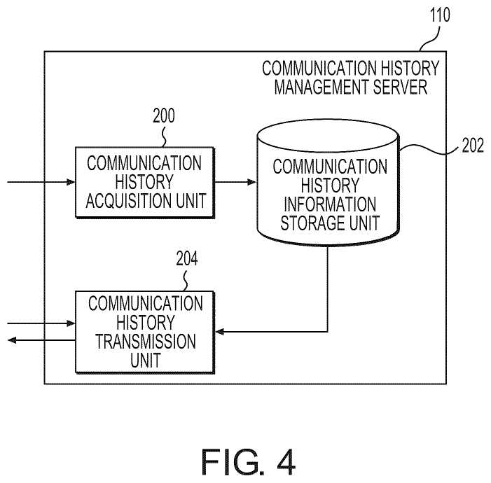

Referring to FIG. 4, the communication history management server 110 includes a processor with a communication history acquisition unit 200, a communication history information storage unit 202 (memory), and a communication history transmission unit 204.

The communication history acquisition unit 200 acquires, from a plurality of in-vehicle devices, communication history information collected by these in-vehicle devices at various locations and dates and times. The communication history information storage unit 202 accumulates the communication history information received by the communication history acquisition unit 200. The communication history transmission unit 204 transmits the communication history information accumulated in the communication history information storage unit 202 to an in-vehicle device (e.g., the in-vehicle device 102, 104, or 106 shown in FIG. 2, etc.) of a contractor of a communication history management service provided by the communication history management server 110, in response to a transmission request from the in-vehicle device. Note that the device transmitting the communication history information to the communication history acquisition unit 200 is not limited to the in-vehicle device. Any device having a communication function, such as a mobile phone, may be used. A movable device such as a mobile phone is more desirable, but a device that is not movable but has a communication function, such as a road-side device, may also be used. Further, the communication history transmission unit 204 may also transmit the communication history information to each in-vehicle device in accordance with a predetermined schedule, instead of only responding to the transmission request from the in-vehicle device.

### A5) Configuration of Communication History Information DB 156

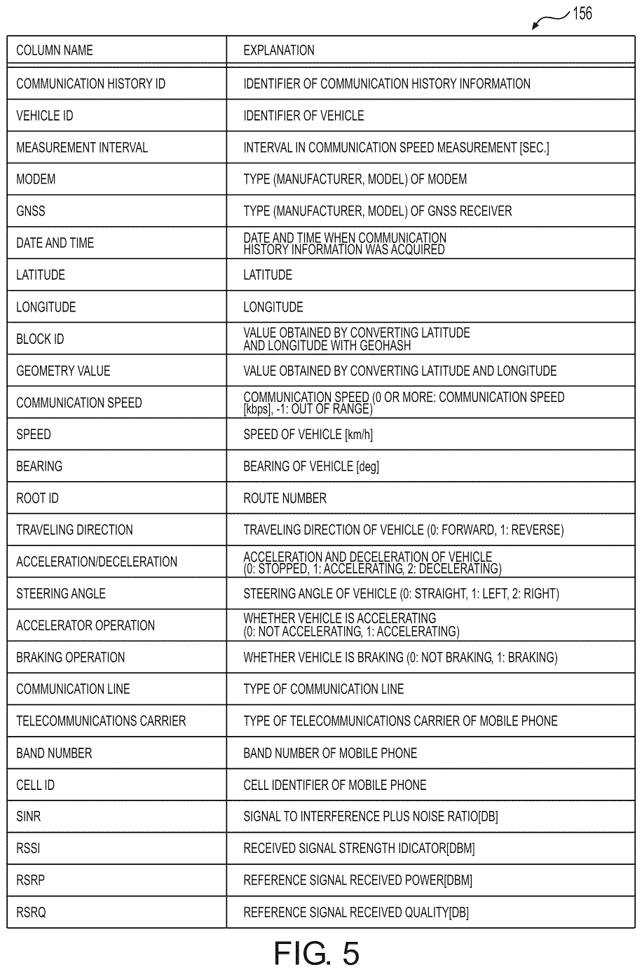

FIG. 5 shows an example of a column configuration of a table in the communication history information DB 156. Referring to FIG. 5, the communication history information DB 156 includes columns for the communication history ID and vehicle ID. The communication history ID is an identifier that specifies a communication history record. The vehicle ID is an identifier that specifies a vehicle in which the in-vehicle device that recorded the communication history is installed.

The other columns are, for example, for the measurement interval, modem, GNSS, date and time, latitude, longitude, block ID, geometry value, communication speed, speed (of the vehicle), bearing (of the vehicle), route ID, traveling direction (of the vehicle), acceleration and deceleration (of the vehicle), steering angle (of the vehicle), acceleration operation, braking operation, communication line, telecommunications carrier, Band number, cell ID (of a mobile phone), SINR, RSSI, RSRP, RSRQ, and the like.

The main ones among the above items are as follows: the measurement interval indicates an interval in the measurement of the communication speed. The unit of the measurement interval is second. The date and time indicates the date and time when the in-vehicle device acquired the communication history. The latitude and longitude indicate the position where the vehicle was present during communication. The block ID refers to a value obtained by converting the latitude and longitude into a character string by a conversion method called Geohash. Geohash is obtained by converting the latitude and the longitude into a character string by applying a predetermined conversion table thereto. Each character string identifies a certain rectangular area on the ground. The longer the character string length, the smaller the rectangular area. If two character strings match each other in the length from the beginning to the predetermined number of digits, the two rectangular areas specified by the two character strings are in the rectangular area specified by the matched character string. If the character string lengths used as Geohashes are the same, the rectangular areas identified thereby have the same size (area). Thus, by setting the character string length used as a Geohash to a constant length and using characters at the beginning in common, the map (or a corresponding region) can be divided into a plurality of rectangular areas adjacent to each other. Here, such a rectangular area is referred to as a block, and its identifier (the latitude and the longitude converted into a Geohash) is referred to as a block ID.

The communication speed represents the communication speed measured for actually performed communication if the communication was possible at the time indicated by the value in the date and time column. If the communication was impossible because, for example, the vehicle was outside the service area, “−1” is recorded as the communication speed in this embodiment.

SINR, RSRP, and RSRQ respectively refer to a signal-to-interference-plus-noise ratio, a received signal strength, received power of a reference signal, and received quality of the reference signal, and correspond to the above-mentioned radio field strength information.

As described above, the communication history information DB 156 stores information indicating the communication quality including the communication speed measured in actual communication, together with the state of the vehicle (speed, traveling direction, etc. of the vehicle shown in FIG. 5) at that time, and the date and time. This processing updates the communication history information DB 156. Note that the values such as the communication speed, SINR, RSSI, RSRP, and RSRQ shown in FIG. 5, and statistical values thereof are considered to be indicators representing the quality of communication. Thus, these values are referred to herein as “communication quality metrics”, and information indicating these values is referred to as “communication quality metrics information”.

### A6) Control Structure of Program

### A6-1) Communication History Recording Unit 154

The functional units of the in-vehicle device 102 shown in FIG. 3 are implemented by a computer and a program executed by the computer.

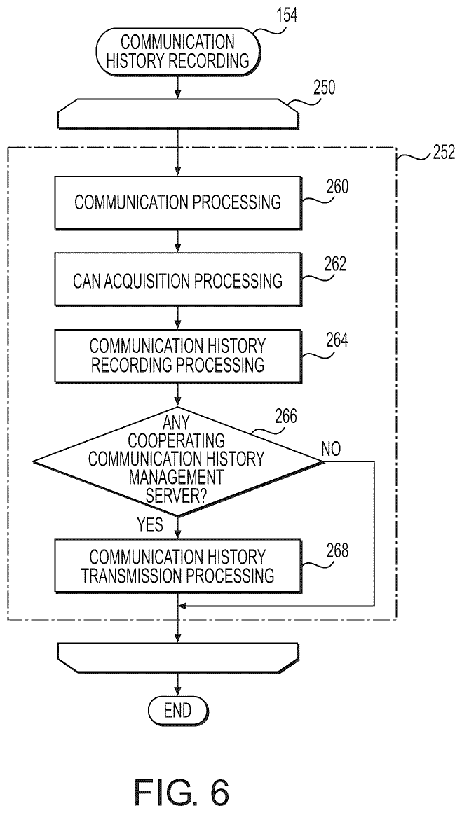

FIG. 6 shows a control structure of a program that implements the communication history recording unit 154 shown in FIG. 3. Referring to FIG. 6, the program includes step 250 of executing step 252 in accordance with a predetermined schedule (a fixed period in this embodiment).
Step 252 includes: step 260 of performing communication processing using the communication unit 150 or signal strength measurement processing; step 262 of acquiring information indicating the state of the vehicle via the CAN 152; and step 264 of combining the information acquired in steps 260 and 262 and recording the combined information in the communication history information DB 156.

The program further includes: step 266 of branching the flow of control in accordance with whether or not there is a communication history management server that cooperates with the in-vehicle device 102; and step 268 of, if the determination result in step 266 is positive, transmitting communication history information to the cooperating communication history management server and ending the execution of step 252. If the determination result in step 266 is negative, the execution of step 252 ends.

### A6-2) Route Calculation Unit 164

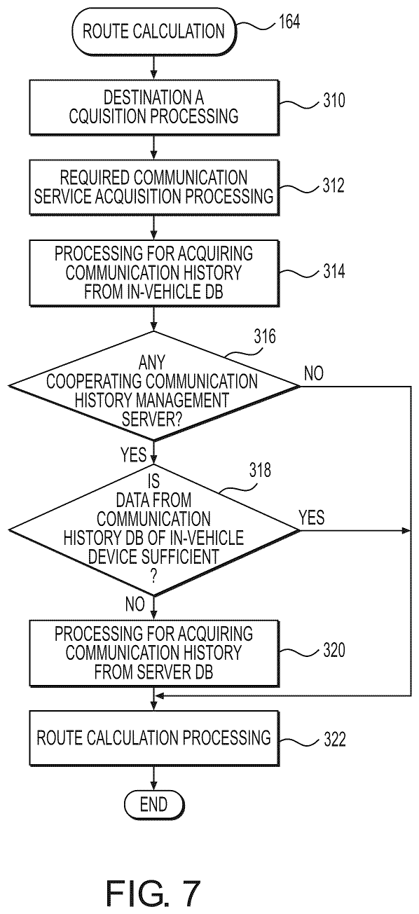

FIG. 7 shows a control structure of a program that implements the route calculation unit 164 shown in FIG. 3. Referring to FIG. 7, the program includes: step 310 of acquiring the position of the destination by interaction with the user; and step 312 of acquiring information related to a communication service required to receive the service provided by the server 108 (information related to the required communication speed, e.g., bit rate etc.).

The program further includes: step 314 of acquiring communication history information regarding an area covering a region around of the current position and a region around the destination from the communication history information DB 156 (FIG. 3); step 316 of branching the flow of control in accordance with whether or not there is a communication history management server that cooperates with the in-vehicle device 102; and step 318 of, if the determination result in step 316 is positive, branching the flow of control in accordance with whether or not data from the communication history information DB 156 is sufficient for route calculation.

The program further includes: step 320 of, if the determination result in step 318 is negative, acquiring communication history information regarding an area covering a region around the current position and a region around the destination from the communication history management server (the communication history management server 110 shown in FIG. 2 in this example), which cooperates with the in-vehicle device 102; and step 322 of calculating a travel route using the acquired communication history information, providing information related to the calculated travel route to the driving unit 162, and ending the execution of the program. If the determination result in step 316 is negative, or if the determination result in step 318 is positive, step 320 is not executed, and the route calculation processing in step 322 is executed immediately.

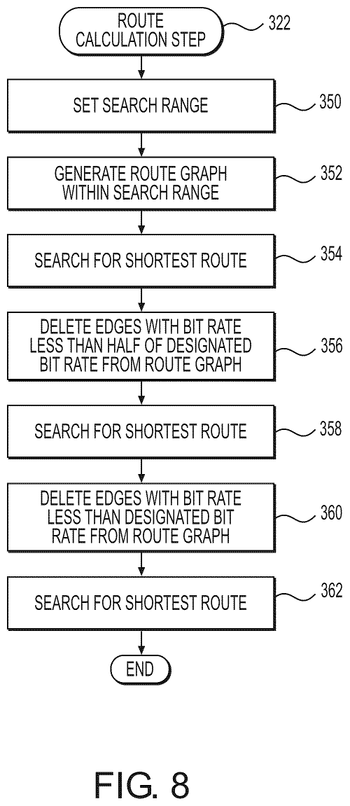

FIG. 8 shows a control structure of a program that implements step 322 shown in FIG. 7. Referring to FIG. 8, step 322 includes: step 350 of setting a search range for the travel route; and step 352 of generating a route graph connecting the current position and the destination based on map information provided in the driving unit 162 within the search range. The route graph here refers to a graph with intersections as nodes and roads connecting intersections and intersections as edges (links). In this embodiment, each edge is provided with information indicating the length of a corresponding road. In this route graph, there are a large number of routes connecting the current position and the destination.

The program further includes step 354 of searching for the shortest route from the current position to the destination in the route graph generated in step 352. In this embodiment, the Dijkstra method is used to search for the shortest path. Needless to say, without being limited to the Dijkstra method, any algorithm may be used with which the shortest path of the graph can be obtained.

The program further includes: step 356 of referencing the communication history information and deleting, from the route graph, edges including a location at which the bit rate is less than half of that designated by the service; step 358 of searching for the shortest route in the route graph after being subjected to the processing in step 356; step 360 of further deleting links including a location at which the bit rate is less than the designated bit rate from the route graph; and step 362 of searching for the shortest route in the route graph after being subjected to the processing in step 360 and ending step 322.

The above processing makes it possible to specify the travel route that is shortest regardless of the designated bit rate, the shortest travel route where communication can be performed at at least half or more of the designated bit rate, and the shortest travel route where communication can be performed at the designated bit rate or faster.

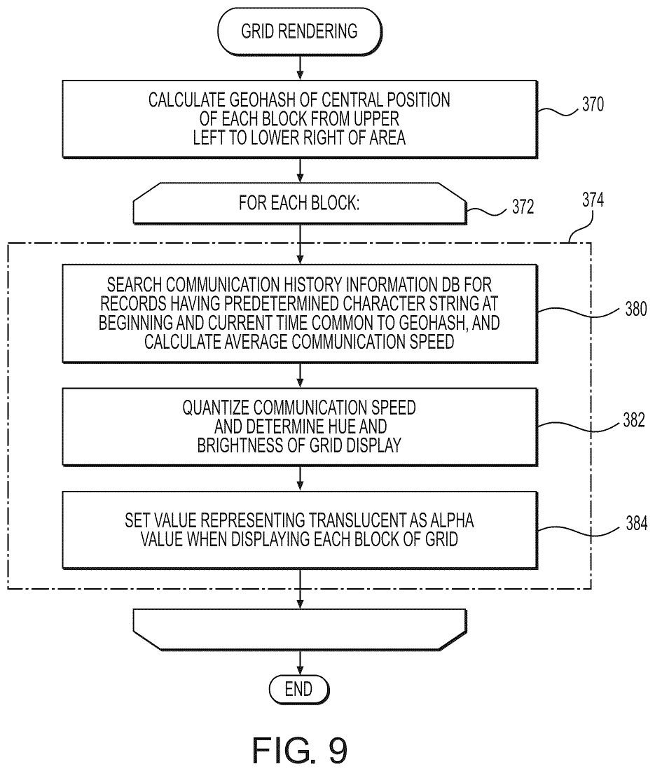

FIG. 9 shows a control structure of a program that implements the grid rendering unit 166 shown in FIG. 3. A grid diagram obtained by the grid rendering unit 166 is, for example, the grid shown in FIG. 1. In FIG. 1, each block in the grid is displayed in a different display mode depending on the communication speed available in that block. The plurality of travel routes generated in step 322 in FIG. 7 are displayed superimposed on a predetermined map, and a translucent grid is further superimposed.

Referring to FIG. 9, the program includes step 370 of acquiring a Geohash value representing an area displayed on the touchscreen display device 116 and dividing this area into a predetermined number of block areas from the upper left to the lower right. In step 370, a Geohash of a predetermined position (e.g., central position) in each block area is also calculated.

The program further includes step 372 of executing step 374 for each block area obtained in step 370.
Step 374 includes: step 380 of searching the communication history information DB 156 for records each of which has the same character string as the Geohash of that block area at the beginning and has a time indicated by the date and time of the record that is within a predetermined range with the current time at the center, and calculating an average communication speed of those records; and step 382 of quantizing the average communication speed calculated in step 380 into some stages and determining the display color (hue) and brightness of the target block area. In this embodiment, the hue is red, and the brightness is determined as a monotonic function of the communication speed such that the lower the communication speed is, the lower the brightness is, and the higher the communication speed is, the higher the brightness is. Note that in this embodiment, the brightness is set to the maximum value when the communication speed is greater than a predetermined threshold.

Step 374 further includes step 384 of setting a value representing translucent as an alpha value for display of each block area, and ending step 374. At this time, the alpha value is set such that the block having the maximum brightness is displayed transparent.

### B. Operation

### B1) Accumulation of Communication History

While the vehicle equipped with the in-vehicle device 102 is moving, the communication unit 150 periodically measures the communication speed and radio field strength. When communication is not performed, the communication unit 150 measures only the radio field strength. The communication unit 150 provides that information as communication history to the communication history recording unit 154.

The communication history recording unit 154 receives information indicating the state of the vehicle from the sensor 112 and the GNSS receiver 114 via the CAN 152. The communication history recording unit 154 generates communication history information using the communication history received from the communication unit 150 and information representing the state of the vehicle, and accumulates the generated information in the communication history information DB 156.

### B2) Input of Destination

When heading for the destination, the user causes an initial screen for route setting to be displayed by interaction using the touchscreen display device 116, and designates the destination and the service to be used. In step 310 in FIG. 7, the in-vehicle device 102 acquires the designated destination and specifies the position thereof. In step 312, the route calculation unit 164 acquires information related to the communication service requested by the service specified by the user (step 312). As a result of this processing, the required bit rate is determined.

The route calculation unit 164 also acquires communication history information related to an area connecting the vicinity of the current position and the vicinity of the destination from the communication history information DB 156 (step 314 in FIG. 7). If there is no communication history management server cooperating with the in-vehicle device 102 (the determination result in step 316 in FIG. 7 is negative), the route calculation unit 164 executes route calculation processing (step 322 in FIG. 7). If there is a communication history management server cooperating with the in-vehicle device 102 (the determination result in step 316 in FIG. 7 is positive), it is determined whether or not the communication history acquired from the communication history information DB 156 is sufficient to determine a travel route based on the bit rate determined for the target area (step 318). If the determination result in step 318 is positive, the route calculation unit 164 calculates a travel route using only the communication history obtained from the communication history information DB 156 (step 322). If the determination result in step 318 is negative, the route calculation unit 164 instructs the communication history acquisition unit 160 to acquire the communication history information regarding the target range from the communication history management server 110. The communication history acquisition unit 160 adds the acquired communication history information to the communication history information DB 156, and the route calculation unit 164 re-acquires the communication history information from the communication history information DB 156 and then calculates a travel route by using the re-acquired communication history information (step 322).

### B3) Route Calculation

The route calculation unit 164 of the in-vehicle device 102 calculates a travel route in the following manner. Referring to FIG. 8, a search range for the travel route is determined based on the relationship between the current position and the destination (step 350). Various methods of determining this search range can be considered. In this embodiment, the search range is a rectangle having as a diagonal line a line connecting the current position and the destination. Needless to say, the search range is not limited thereto, and various other methods can also be considered.

Subsequently, the route calculation unit 164 generates a route graph based on information regarding intersections present within the search range determined in step 350 and roads connecting these intersections (step 352). At this time, roads having a smaller road width than a certain value may be removed from the route graph.

The route calculation unit 164 generates a travel route consisting of the shortest route from the current position to the destination by applying the Dijkstra method to the thus-generated route graph (step 352). When generating the travel route here, the communication speed in the middle of traveling along this travel route is not considered. That is, the travel route generated in step 352 is the shortest route when it is selected that no service provided via communication is to be received.

In step 356, the route calculation unit 164 also deletes edges with a communication speed less than half the designated bit rate from the route graph. As a result, the remaining edges have half or more of the designated bit rate. The route calculation unit 164 searches for the shortest route in this route graph in step 358. This route is the shortest of the travel routes where a bit rate higher than or equal to half the designated bit rate is expected to be available.

In step 360, the route calculation unit 164 also deletes edges with a bit rate less than the designated bit rate from the route graph. In the following step 362, the shortest route in the resulting route graph is searched. The travel route obtained by this processing is the shortest travel route among the travel routes where a communication speed greater than or equal to the designated bit rate is expected.

Thus, a plurality of travel routes are calculated based on the constraint conditions designated by the user.

Note that the constraint conditions are not limited to those described above, and various other constraint conditions can also be considered. For them, for example, it is possible to prepare programs including a series of procedures such as steps 352 and 354 in FIG. 8 and execute an appropriate program based on the user's designation. Preferably, the execution order of the programs is also designated in advance. By executing the program in accordance with such designation, the amount of calculation required to calculate the travel routes can be reduced.

### B4) Display of Route Suggestion Screen

When the travel routes are calculated by the above processing, the driving unit 162 generates the route suggestion screen 50 shown in FIG. 1 and displays it on the touchscreen display device 116. The driving unit 162 first displays a map of the corresponding area. The driving unit 162 also displays the three calculated travel routes superimposed on the map. The travel routes can be displayed by continuously rendering rectangles connecting the start point and the end point of each edge forming each travel route.

The grid rendering unit 166 creates a grid display as shown in FIG. 1 as follows. Referring to FIG. 9, the grid rendering unit 166 acquires a Geohash value representing the area to be displayed on the touchscreen display device 116 and divides this area into a predetermined number of block areas from the upper left to the lower right (step 370). At this time, a Geohash of a predetermined position (e.g., central position) in each block area is calculated.

The grid rendering unit 166 further executes the following step 374 for each block area.

In step 374, the grid rendering unit 166 searches the communication history information DB 156 for records each of which has the same character string as the Geohash of the target block area at the beginning and has a time indicated by the date and time of the record that is within a predetermined range with the current time at the center, and calculates an average communication speed of those records (step 380). The grid rendering unit 166 also quantizes the average communication speed calculated in step 380 into some stages and determines the display color (hue) and the brightness of the target block area (step 382). In this embodiment, the hue is red, and the brightness is determined as a monotonic function of the communication speed such that the lower the communication speed is, the lower the brightness is, and the higher the communication speed is, the higher the brightness is.

The grid rendering unit 166 also sets a value representing translucent as an alpha value for display of each block area (step 384). At this time, the grid rendering unit 166 sets the alpha value such that the block having the maximum brightness is displayed transparent. The thus-created image of the block area is superimposed on the map and images of the travel routes by the driving unit 162. As a result, the map, the travel routes, and the grid are displayed in a superimposed manner in the display screen of the touchscreen display device 116, as shown in FIG. 1. In an area with high communication speed, the map is displayed as it is. An area with low communication speed is displayed translucent as a red area with a brightness according to the value of the communication speed on the map. The lower the communication speed is, the darker each area is displayed in red, and the higher the communication speed is, the brighter each area is displayed in red.

As described above, according to this embodiment, the communication speed actually measured in the past is accumulated in the communication history information DB 156 and used for calculating travel routes. As a result, it is possible to calculate appropriate travel routes appropriate for the bit rate required by the service to be used. When calculating the travel routes, a plurality of travel routes are calculated based on the constraints designated by the user. The user can select an appropriate travel route depending on how to use the service.

Also, the state of communication speed in the areas surrounding the current position and the destination is visually displayed. This allows the user to select an appropriate travel route in accordance with the purpose of using the service, the communication status, and the distance to the destination; for example, how extensive the service using communication will be provided while traveling from the current position to the destination, which route is to be adopted to fully use the service, and so on.

The communication history management server 110 accumulates communication history information from each vehicle. Thus, when a certain in-vehicle device calculates a travel route, if sufficient communication history is not stored in the in-vehicle device, necessary communication history information can be retrieved from the communication history management server 110. As a result, optimal travel routes for using the communication service over a wide area can be calculated.

In the first embodiment, the user selects one of the three travel routes displayed on the touchscreen display device 116. However, this disclosure is not limited to such an embodiment. An embodiment is also possible in which a travel route is selected where the required communication speed can be continuously maintained, or if such a route does not exist, a travel route with the highest average communication speed in the middle of traveling is automatically selected.

### 2. SECOND EMBODIMENT

### A. Configuration

### A1) Vehicle Assistance System 400

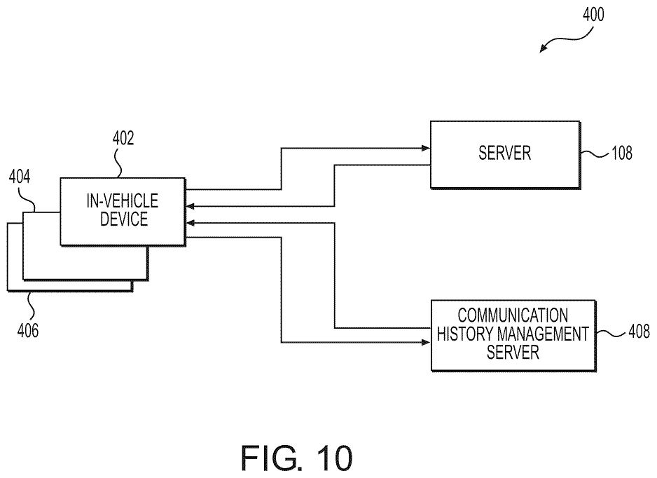

FIG. 10 shows a configuration of a vehicle assistance system 400 according to the second embodiment. Referring to FIG. 10, the vehicle assistance system 400 according to the second embodiment includes: a server 108; in-vehicle devices 402, 404, 406, and so on that use services provided by the server 108; and a communication history management server 408 that accumulates communication history information regarding a plurality of in-vehicle devices such as the in-vehicle device 402 and transmitting the communication history information to each in-vehicle device in response to a request.

In this embodiment, unlike the first embodiment, the route calculation unit is not included in the in-vehicle device 402 but is included in the communication history management server 408.

### A2) In-Vehicle Device 402

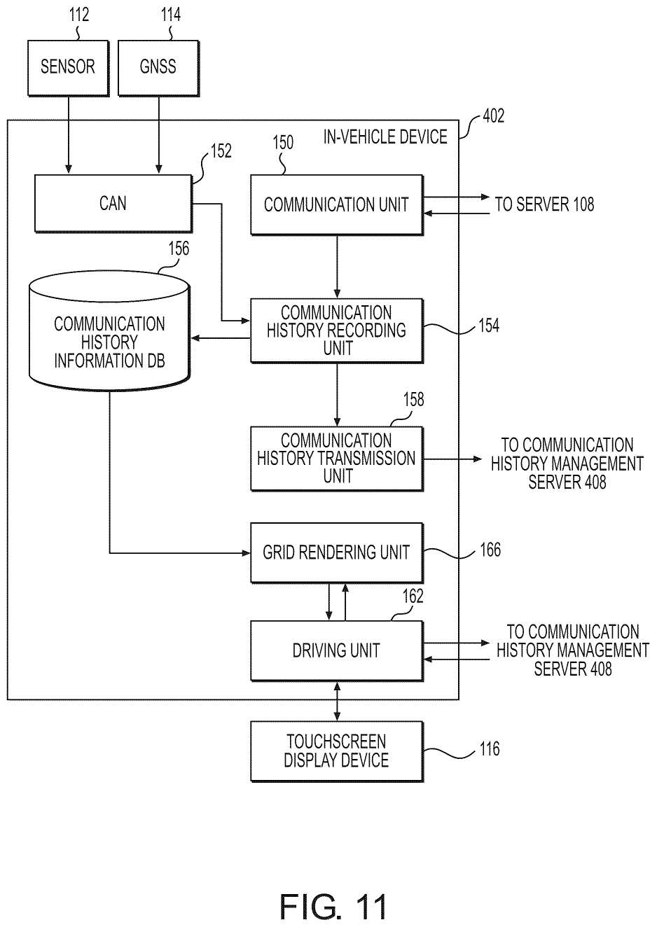

Referring to FIG. 11, the in-vehicle device 402 is different from the in-vehicle device 102 shown in FIG. 3 in that the in-vehicle device 402 does not include the communication history acquisition unit 160 and the route calculation unit 164.

Further, the driving unit 162 is different from the driving unit 162 shown in FIG. 3 in that the driving unit 162 makes a request for necessary communication history information to the communication history management server 408, rather than the communication history information DB 156, based on information related to a destination input by the user using the touchscreen display device 116.

### A3) Communication History Management Server 408

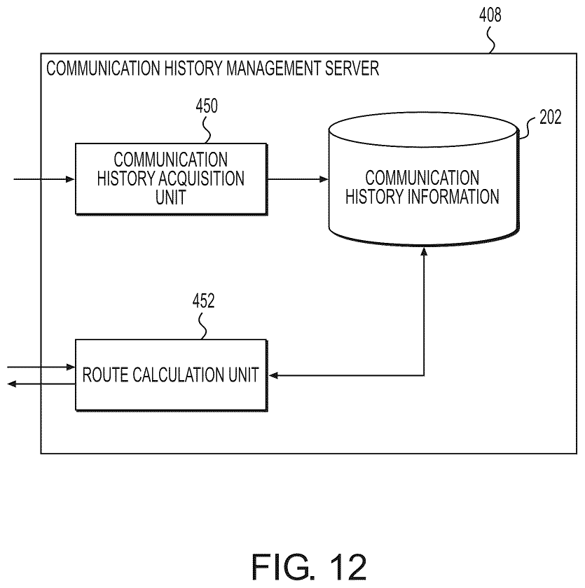

Referring to FIG. 12, the communication history management server 408 includes: a communication history acquisition unit 450 that acquires communication history information from a plurality of in-vehicle devices; a communication history information storage unit 202 for accumulating the communication history information acquired by the communication history acquisition unit 450; and a route calculation unit 452 for receiving a travel route calculation request specifying the current position and the destination from the driving unit 162 of an in-vehicle device such as the in-vehicle device 40 shown in FIG. 10, reading the communication history information regarding the corresponding area from the communication history information storage unit 202, and transmitting the read information to the in-vehicle device 402.

### B. Operation

The second embodiment is different only in that, when the destination is input via the touchscreen display device 116, the driving unit 162 makes a request for communication history information to the route calculation unit 452 of the communication history management server 408, rather than the communication history information DB 156, while designating the current position and the destination, and in that, in response to this request, the route calculation unit 452 reads the communication history information regarding the corresponding area from the communication history information storage unit 202 and transmitting the read information to the driving unit 162. In other respects, each functional unit of the vehicle assistance system 400 operates in the same manner as the corresponding functional unit of the first embodiment.

### 3. THIRD EMBODIMENT

### A. Configuration

### A1) Vehicle Assistance System 500

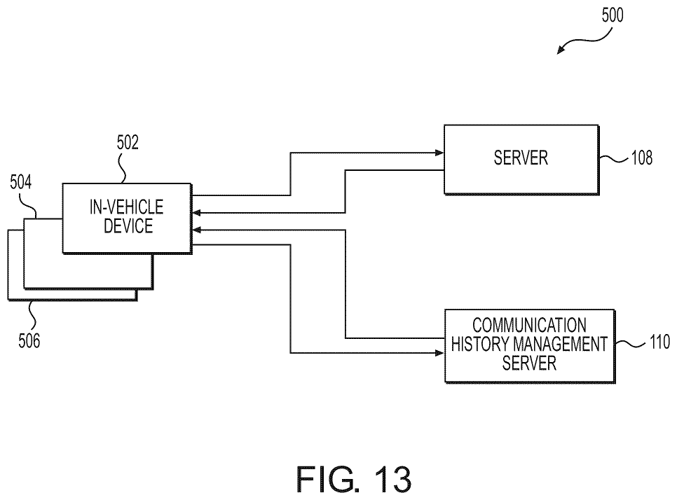

Referring to FIG. 13, a vehicle assistance system 500 according to the third embodiment of the disclosure includes a server 108, in-vehicle devices 502, 504, 506, and so on, and a communication history management server 110. The server 108 and the communication history management server 110 are the same as the server 108 and the communication history management server 110 in the first embodiment shown in FIG. 2.

### A2) In-Vehicle Device 502

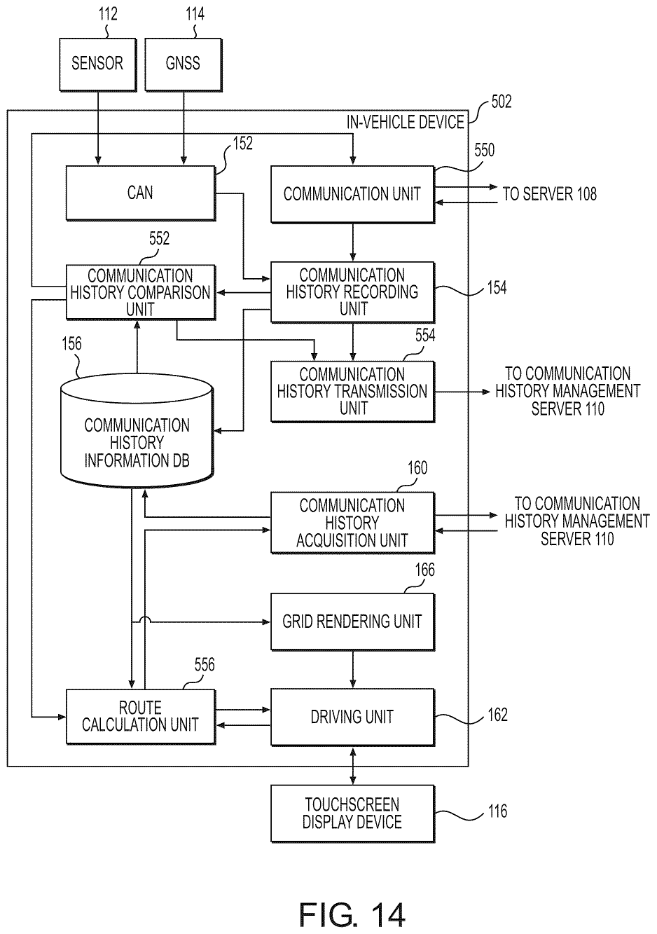

Referring to FIG. 14, the in-vehicle device 502 is similar to the in-vehicle device 102 shown in FIG. 3. However, unlike the in-vehicle device 102, the in-vehicle device 502 includes a communication history comparison unit 552 that receives a measurement result related to the current communication speed from the communication history recording unit 154, compares the received measurement result with a communication speed estimated from information stored in the communication history information DB 156 to calculate a difference therebetween, and outputs the resulting value. Furthermore, in place of the communication unit 150 shown in FIG. 3, the in-vehicle device 502 further includes a communication unit 550 that has a function of adjusting the bit rate for the service received from the server 108 in response to the difference output by the communication history comparison unit 552 being greater than a threshold. When the actual speed measured by the communication history recording unit 154 becomes smaller than a predicted speed by a threshold or more, the communication unit 550 requests the server 108 to reduce the bit rate of the service using the server 108. As a result, if the service provided by server 108 is, for example, video streaming or the like, the server 108 reduces the resolution of the video or reduces the number of transmission frames such that the vehicle can continue to use the service. Conversely, if the actual measured value is greater than the prediction by a threshold or more, the communication unit 550 requests the server 108 to increase the bit rate to be used for the service if possible.

Further, in place of the route calculation unit 164 shown in FIG. 3, the in-vehicle device 502 includes a route calculation unit 556 that has a function of redoing route calculation when the absolute value of the value output by the communication history comparison unit 552 is greater than a threshold, in addition to the functions of the route calculation unit 164. Furthermore, in place of the communication history transmission unit 158 shown in FIG. 3, the in-vehicle device 502 includes a communication history transmission unit 554 that immediately transmits communication history information created from the latest measurement result measured by the communication history recording unit 154 to the server 108 when the absolute value of the value output by the communication history comparison unit 552 is greater than or equal to a threshold, in addition to the functions of the communication history transmission unit 158.

### A3) Communication History Comparison Unit 552

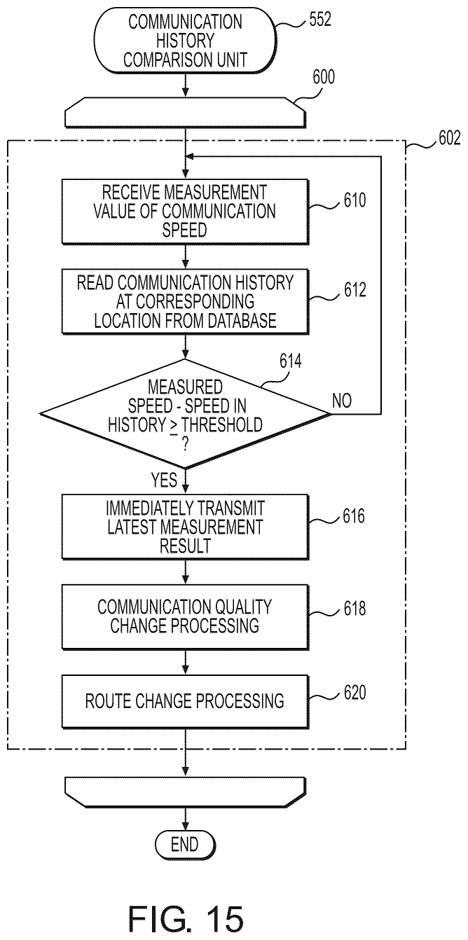

FIG. 15 shows a control structure of a program that implements the communication history comparison unit 552. Referring to FIG. 15, the program includes step 600 of repeatedly executing step 602.

Step 602 includes: step 610 of receiving the latest measurement value of the communication speed from the communication history recording unit 154; step 612 of reading the past communication history information regarding the current position from the communication history information DB 156; and step 614 of branching the flow of control in accordance with whether or not a difference between the latest measurement result and the communication speed in the communication history read in step 612 is greater than or equal to a threshold. If the determination result in step 614 is negative, the processing for the latest measurement result in step 602 ends.

The program further includes, when the determination result in step 614 is positive: step 616 of immediately transmitting the communication history information obtained from the latest measurement result to the communication history management server 110; step 618 of changing communication quality with the server 108 by controlling the communication unit 550 based on the latest measurement result; and step 620 of executing a route change to calculate travel routes again by controlling the route calculation unit 556, and ending the execution of step 602. Note that in this embodiment, it is assumed that the result of the route change is not presented to the user and is immediately reflected on the operation of the driving unit 162.

### B. Operation

Referring to FIG. 14, similar to the communication unit 150 in the other embodiments, the communication unit 550 periodically measures the communication speed and radio field strength when communication is performed, and measures only the radio field strength when communication is not performed, and provides the measurement result to the communication history recording unit 154. The communication history recording unit 154 operates in the same manner as in FIG. 3. However, the communication history recording unit 154 also provides the latest communication history to the communication history comparison unit 552.

The communication history comparison unit 552 receives the latest communication history from the communication unit 550 (step 610 in FIG. 15), reads, based on the current position of the in-vehicle device 502, the past communication history at that location from the communication history information DB 156, and subtracts the speed in the past communication history from the latest measurement speed (step 612). If the absolute value of the subtraction result is greater than a threshold (the determination result in step 614 is positive), the communication history comparison unit 552 provides the communication history based on the latest measurement result to the communication history transmission unit 554 (step 616). The communication history comparison unit 552 also provides the subtraction result in step 614 to the communication unit 550 (step 618). Similarly, the communication history comparison unit 552 provides the communication history based on the latest measurement result to the route calculation unit 556 (step 618).

As a result, the communication history transmission unit 554 immediately transmits the communication history based on the latest measurement result to the communication history management server 110. The communication history management server 110 stores the received communication history in the communication history information storage unit 202 (see FIG. 4). The communication unit 550 requests the server 108 to adjust the bit rate of the service provided by the server 108 based on the latest measurement result. The route calculation unit 556 re-executes travel route calculation based on the latest measurement result and controls the driving unit 162 so as to change the travel routes in accordance with the result.

As described above, according to the third embodiment, if the latest measurement result related to the communication speed is significantly different from the past communication history, the latest measurement result is immediately transmitted as communication history to the communication history management server 110. As a result, the latest measurement result is immediately reflected in the communication history management server 110. Similarly, the communication unit 550 changes the bit rate of the service received from the server 108 in accordance with the communication speed based on the latest measurement result. As a result, if the communication speed decreases, the service is also changed to one with a correspondingly lower bit rate. Conversely, if the communication speed increases, the service is changed to one with a correspondingly higher bit rate. For example, in the case of video streaming or the like, the service can be maintained by thus changing the resolution or frame rate of the image in accordance with the available communication speed. Also, a route change is automatically performed, allowing a course with better communication quality to be selected. As a result, the user can use the service under better conditions.

### 4. FOURTH EMBODIMENT

### A. Configuration

### A1) Drive Assistance System 650

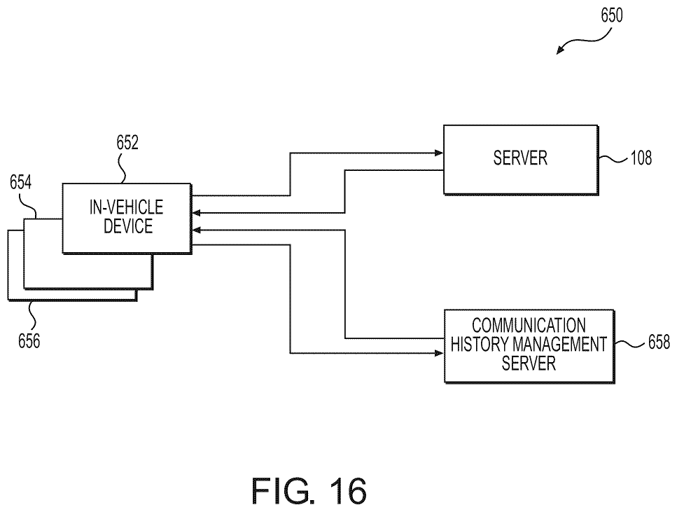

Referring to FIG. 16, a drive assistance system 650 according to the fourth embodiment of the disclosure includes a server 108, in-vehicle devices including in-vehicle devices 652, 654, and 656, and a communication history management server 658.

The in-vehicle device 652 according to the fourth embodiment is different from the in-vehicle device 102 in that the in-vehicle device 652 performs statistics processing on the communication history stored in the communication history information DB 156, and suggests travel routes based on the results of the statistics processing, in addition to the functions of the in-vehicle device 102 shown in FIG. 3. In this statistics processing, a value (e.g., “−1” etc.) indicating that communication could not be performed is excluded from the calculation of values such as an average value. However, such a value is counted when statistics information related to whether or not communication was possible is calculated.

### A2) In-Vehicle Device 652

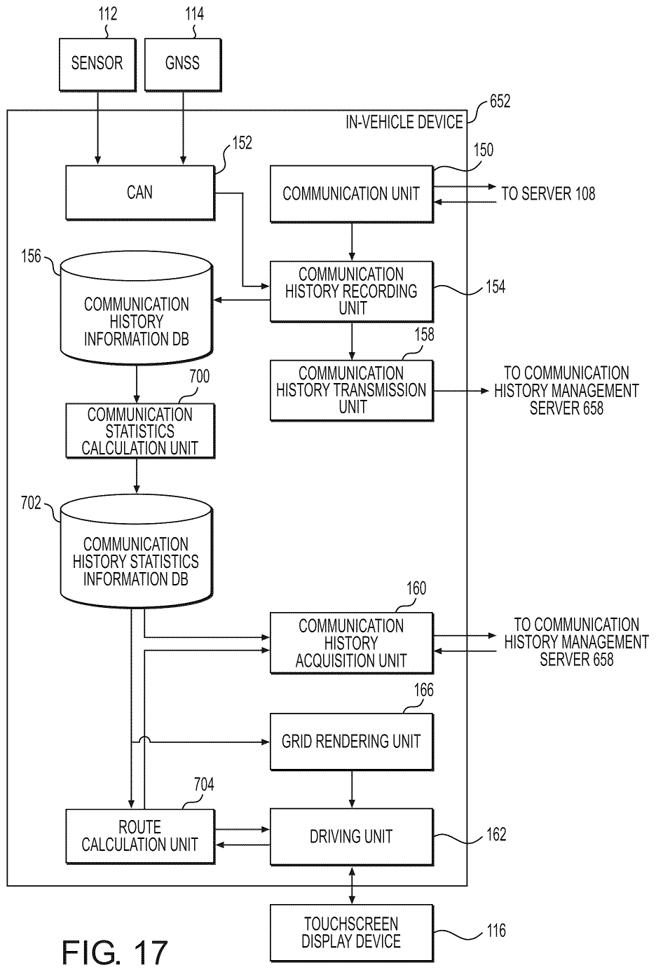

Referring to FIG. 17, the in-vehicle device 652 includes: a communication statistics calculation unit 700 that executes predetermined statistics processing on the communication history information stored in the communication history information DB 156; a communication history statistics information DB 702 for storing statistics information related to communication calculated by the communication statistics calculation unit 700; and a route calculation unit 704 that calculates a travel route using the communication history statistics information stored in the communication history statistics information DB 702, in addition to the units of the in-vehicle device 102 shown in FIG. 3, as mentioned above.

In this embodiment, when receiving a request to acquire communication history information from the route calculation unit 704, the communication history acquisition unit 160 provides the communication history statistics information stored in the communication history statistics information DB 702, rather than the communication history information DB 156, to the route calculation unit 704. If it is difficult for the route calculation unit 704 to calculate a travel route depending on the communication history statistics information stored in the communication history statistics information DB 702, the communication history acquisition unit 160 receives, from the communication history management server 658, the communication history statistics information stored in the communication history statistics information DB 702. The communication history acquisition unit 160 adds this communication history statistics information to the communication history statistics information DB 702, and also provides it to the route calculation unit 704. The route calculation unit 704 is different from the route calculation unit 164 in that the communication history used when calculating a travel route is not information on actual measurement stored in the communication history information DB 156 but information after being subjected to statistics processing stored in the communication history statistics information DB 702.

### A3) Communication History Management Server 658

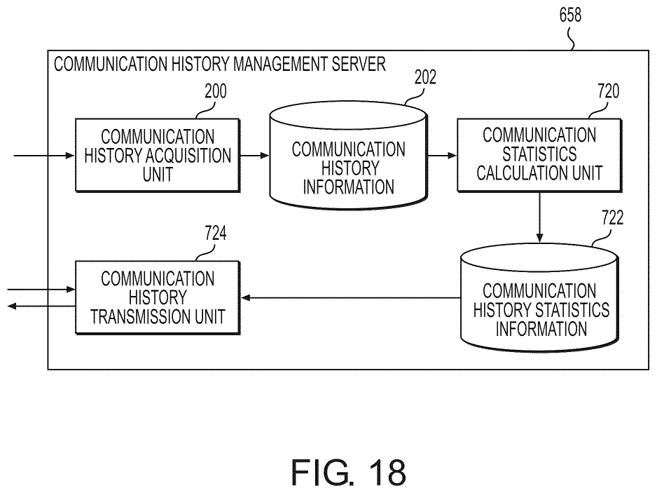

Referring to FIG. 18, the communication history management server 658 includes: a communication history acquisition unit 200; a communication history information storage unit 202; and a communication statistics calculation unit 720 for performing the same statistics processing as that of the communication statistics calculation unit 700 shown in FIG. 17, on the communication history information stored in the communication history information storage unit 202. The communication history management server 658 further includes: a communication history statistics information storage unit 722 for storing statistics information related to the communication history that is calculated by the communication statistics calculation unit 720; and a communication history transmission unit 724 for, in response to a request from the communication history acquisition unit 160 shown in FIG. 17, reading the communication history statistics information corresponding to the current location designated by the communication history acquisition unit 160 from the communication history statistics information storage unit 722, and transmitting the read information to the communication history acquisition unit 160.

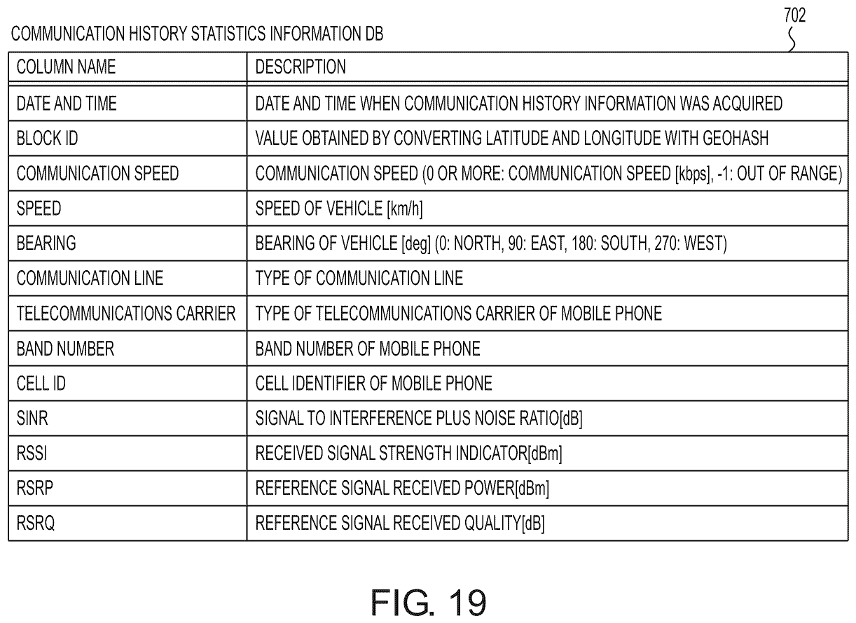

FIG. 19 shows a column configuration of the communication history statistics information DB 702 shown in FIG. 17. The communication history statistics information storage unit 722 shown in FIG. 18 also has the same column configuration.

Referring to FIG. 19, the communication history statistics information DB 702 includes: a date and time column; a block ID column; a communication speed column; a speed column; a bearing column; a communication line column; a telecommunications carrier column; a Band number column; a cell ID column; and SINR, RSSI, RSRP, and RSRQ columns, which are the same as those shown in FIG. 5.

Of the information stored in these columns, the date and time are for specifying the unit period covered by the statistics. For example, if a value indicating a year in the Gregorian calendar (e.g., “2022”) is in in the date and time column, this indicates that the contents of one record in the communication history statistics information DB 702 are statistics covering the entire year of 2022. If information indicating a certain month (e.g., “202206”) is in the date and time column, this indicates that statistics for that information covering one month are stored in that one record. Similarly, by using the date and time column, statistics per each day or each hour, for example, can be stored as one record in the communication history statistics information DB 702. By thus including date and time information in the records, statistics information can be recorded hierarchically over various periods.

A block ID is an identifier of a Geohash that identifies a block that was a statistic target. This value is a fixed value assigned to each block. However, the block ID also has a hierarchical structure as mentioned above. Therefore, regarding the blocks as well, if the minimum unit of their size is determined and statistical values of the communication status in the blocks are recorded, statistics for a larger block can be calculated at any timing. In this manner, statistics information can be calculated and recorded with a geographically and temporally hierarchical structure by using the values in the date and time column and the values in the block ID column.

In FIG. 19, the columns below the communication speed contain values after being subjected to statistics processing. Methods of statistics processing adopted for each of these columns differ depending on the column. For example, for the communication speed, speed, bearing, SINR, RSSI, RSRP, RSRQ, and the like, any of a representative value obtained by statistics processing, e.g., any of an average value, a maximum value, a minimum value, and a value such as CDF (cumulative distribution function), or any combination thereof is stored. For the bearing, the bearing may be digitized and averaged, or 360 degrees may be divided into predetermined angles and the number of the value within each angular range may be counted. Although the communication line, telecommunications carrier, Band number, and cell ID are all discrete values, those used within a target unit period may be counted and recorded per type.

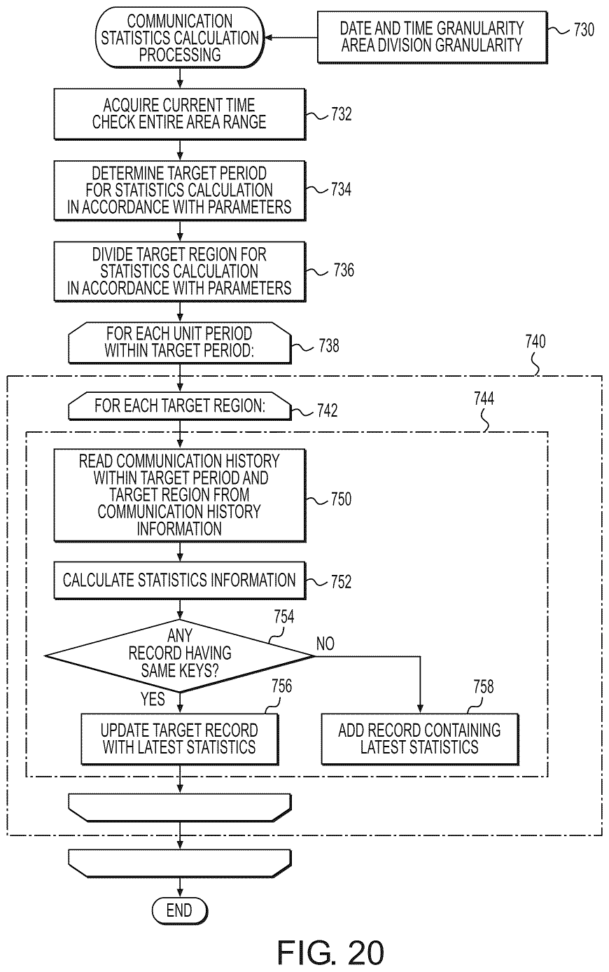

FIG. 20 shows a control structure of a program that causes a computer to function as the communication statistics calculation unit 720 shown in FIG. 18. This program is started in response to receiving parameters 730 as arguments that specify the granularity of the period for which statistics calculation is to be performed and the granularity for dividing an area into blocks. The program calculates statistics of communication history for each period of the designated granularity and for each area of the designated granularity. Note that “high granularity” as used herein means that the unit to be processed is large, and “low granularity” means that the unit to be processed is small. Of course, “high/low granularity” is a relative expression.

The program includes step 732 of checking the current time and the range (entire area range) covering all the positions where the information communication history information stored in the communication history information storage unit 202 was acquired. The entire area range is a rectangle in the fourth embodiment, and is designated by the coordinates (latitude and longitude) of the northwest and southeast ends of the rectangle. Of course, the shape designating the entire area range is not limited to a rectangle. Any shape may be used, including those that do not consist of straight lines, such as a circle or an ellipse.

The program further includes: step 734 of determining a target period by dividing the period for statistics calculation in accordance with the parameters 730; and step 736 of determining a set of target regions for statistics calculation by dividing the entire area range in accordance with the specified granularities, according to the parameters 730.

In step 734, basically, the unit period including the current time acquired in step 732 and the immediately previous unit period are the targets. However, if, for example, the complication of statistics has already been completed and it has also been determined that no update is to be performed, the immediately previous unit period is not subjected to statistics calculation.

For example, if the date and time granularity is “day” and the current date is “September 1, 2022”, the date including the current time “September 1, 2022” and the immediately previous date, namely “August 31, 2022” are subjected to statistics calculation. However, if, for example, statistics calculation for “August 31, 2022” has been completed and it has also determined that no update is to be performed, only “September 1, 2022” is subjected to statistics calculation.

If the date and time granularity is “hour” (time) and the current date and time is “September 1, 2022, 11:05:17”, then “September 1, 2022, 11:00” and “September 1, 2022, 10:00” are subjected to statistics calculation. However, if the statistics calculation for “September 1, 2022, 10:00” has been fixed, only “September 1, 2022, 11:00” is subjected to statistics calculation.

In step 736, the rectangular entire area range checked in step 732 is divided into rectangular areas of the size designated by the parameters 730. Each divided area here is assigned a unique Geohash code, as mentioned above.

The program further includes step 738 of executing step 740 for each unit period included in the target period determined in step 734. As mentioned above, the unit period included in the target period is basically one unit period including the current time, or two unit periods including the most recent one unit period.
Step 740 includes step 742 of executing step 744 for each target region divided in step 736.
Step 744 includes: step 750 of reading communication history information from the communication history information storage unit 202 shown in FIG. 18 using the target period and the target region as keys; and step 752 of calculating each piece of statistics information presented in the communication history statistics information DB 702 based on the communication history information read in step 750. For the calculation of statistics information in step 752, different processing is performed for each item. When a relational database is used for the communication history statistics information DB 702, there are cases where the processing in step 732 can be simplified by including a command to calculate a representative statistical value such as an average, maximum value, minimum value, or variance in a query when reading records.

Step 744 further includes step 754 of branching the flow of control in accordance with whether or not a record having the same keys as those used in step 750 is present in the communication history statistics information storage unit 722. Step 744 further includes: step 756 of, when the determination result in step 754 is positive, updating the record having those keys in accordance with the latest statistical values calculated in step 752 and ending step 744; and step 758 of, when the determination result in step 754 is negative, adding a new record containing the statistical values calculated in step 752 to the communication history statistics information storage unit 722 using the target period and the target region used in step 750 as keys, and ending step 744.

The above description relates to the program executed by the communication statistics calculation unit 720 of the communication history management server 658 shown in FIG. 18. Meanwhile, the communication statistics calculation unit 700 of the in-vehicle device 652 shown in FIG. 17 also executes a program having essentially the same control structure as that shown in FIG. 20. However, in the case of the in-vehicle device 652, it is considered that the target region is also limited, and the size of the block used in the route suggestion is also limited. Accordingly, the date and time granularity and the range division granularity when executing the program similar to that shown in FIG. 20 are relatively high. As a result, even a device that is not so much provided with computational resources, such as an in-vehicle device 652, can stably calculate communication statistics.

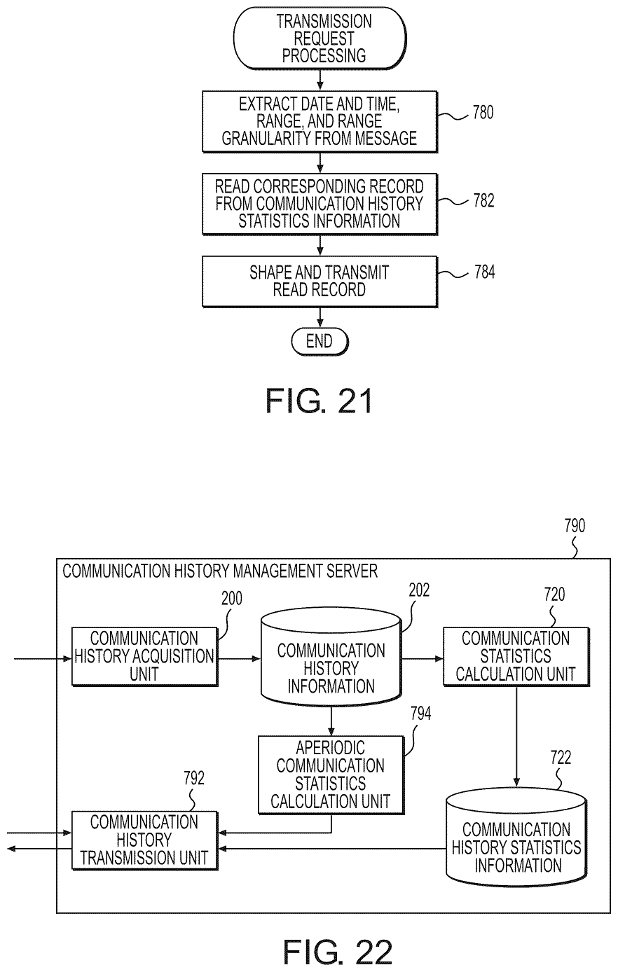

FIG. 21 shows a control structure of a program that causes a computer to function as the communication history transmission unit 724 shown in FIG. 18. This program is started each time the communication history management server 658 receives a request to transmit communication history statistics from an external device.

Referring to FIG. 21, the program includes a step 780 of extracting information indicating the date and time, date and time granularity, range, and range granularity of the communication history statistics to be transmitted, from a received transmission request message. When a date and time is not designated, it is considered that the most recent unit time has been designated. The unit time in this case is determined by the date and time granularity. If the date and time granularity is not designated, the default unit time, e.g., 1 hour, is set as the unit time. The range is required. The range granularity is designated by the number of digits of Geohashes to be used, for example. If the range granularity is not designated, the range granularity is determined as a function of the size of the designated range.

This program further includes, following step 780: step 782 of reading from the communication history statistics information storage unit 722 a record corresponding to the date and time, date and time granularity, range, and range granularity extracted in step 780; and step 784 of shaping the information contained in the record read in step 782 into a predetermined format and transmitting the shaped information to an external device in one or more packets, and ending the execution of this program.

### B. Operation

In this embodiment, the communication history recording unit 154 of the in-vehicle device 652 shown in FIG. 17 periodically acquires communication history information and stores the acquired information in the communication history information DB 156. The communication history transmission unit 158 similarly transmits communication history information to the communication history management server 658. The communication history acquisition unit 200 of the communication history management server 658 shown in FIG. 18 acquires communication history information from a plurality of in-vehicle devices including the in-vehicle device 652 and accumulates the acquired information in the communication history information storage unit 202.

Referring to FIG. 17, in the in-vehicle device 652 in the fourth embodiment, the communication statistics calculation unit 700 performs statistics processing on the communication history information stored in the communication history information DB 156 in accordance with a predetermined schedule, and stores the results in the communication history statistics information DB 702.

The schedule in this case may be a schedule in which statistics processing is executed only once each time the aforementioned minimum time unit elapses, or a schedule in which statistics processing is executed each time a predetermined period longer than the minimum time unit elapses. However, in the fourth embodiment, hierarchical statistics needs to be taken. In such a case, when the statistics processing is executed, not only is processing performed in the minimum time unit, but also higher-layer statistics are also calculated. When calculating higher-layer statistics, the statistics may be calculated directly from the information accumulated in the communication history information DB 156, or lower-layer statistics information stored in the communication history statistics information DB 702 may also be used. In the fourth embodiment, the communication statistics calculation unit 700 uses only the information in the communication history information DB 156, as mentioned above. The load of statistics calculation processing performed by the communication statistics calculation unit 700 is smaller than that of the communication statistics calculation unit 720. Meanwhile, the statistics information accumulated in the communication history statistics information DB 702 is information obtained from information in a relatively limited region, and is also limited, in terms of both time and geography, to statistics information having a higher granularity than the statistics information stored in the communication history statistics information storage unit 722.

Meanwhile, in the communication history management server 658 shown in FIG. 18, the communication statistics calculation unit 720 performs statistics processing on the communication history information accumulated in the communication history information storage unit 202 in accordance with a fixed schedule, similarly to the in-vehicle device 652, and stores the obtained communication history statistics information in the communication history statistics information storage unit 722.

For example, when statistics processing is performed in a daily unit, a program having a control structure shown in FIG. 20 is started for each region in each hierarchy within the range to be managed, with one cycle normally being about 24 hours or 12 hours. For example, if 12 hours is one cycle of statistics processing, then 24 hours of information is processed twice. The first time the processing is performed, the first 12 hours of statistics information is calculated. The second time the processing is performed, 24 hours of statistics information is calculated, and the statistics information calculated based on 12 hours of information is updated therewith.

Regarding the program shown in FIG. 20, a plurality of programs can be started at the same time and can be processed in parallel. When the date and time granularity for statistics information calculation decreases, the range expands, and the range granularity also decreases, the number of target of statistics calculation becomes very large. In such a case, the statistics processing can be performed by a plurality of processors, and each processor further can perform parallel calculations using a GPU to perform necessary statistics processing in a timely manner. The computational resources available for the communication history management server 658 can be increased in accordance with the demand. As a result, even if the demand from external devices increases, it can be addressed flexibly.

When calculating a travel route, the route calculation unit 704 requests the communication history acquisition unit 160 to acquire the communication history of a relevant area while designating the current position and the destination. The communication history acquisition unit 160 causes the communication history statistics information that has been subjected to statistics processing regarding the designated area, out of the information stored in the communication history statistics information DB 702, to be input to the route calculation unit 704. If the information obtained from the communication history statistics information DB 702 is sufficient to calculate travel routes in the designated area, the route calculation unit 704 immediately performs route calculation processing; otherwise, the route calculation unit 704 requests the communication history acquisition unit 160 to acquire communication history statistics information related to the designated area from the communication history management server 658. The communication history acquisition unit 160 transmits a statistics information transmission request to the communication history transmission unit 754 of the communication history management server 658 to obtain the requested information.

The transmission request includes information specifying a temporal range and a geographic range in which statistics information is required, as well as information specifying the granularities thereof. For example, when information in a range that is not covered by the statistics information stored in the communication statistics calculation unit 700 is required, the communication history acquisition unit 160 requests the communication history management server 658 for statistics information related to at least that range. If the communication status per region in detail cannot be determined with the information stored in the communication statistics calculation unit 700, the communication history acquisition unit 160 requests the communication history management server 658 for statistics information regarding divided areas with a lower granularity.

Upon receiving this transmission request, the communication history transmission unit 724 of the communication history management server 658 shown in FIG. 18 executes the program shown in FIG. 21. That is, the communication history transmission unit 724 extracts, from a transmission request message, information indicating the date and time, date and time granularity, range, and range granularity of the statistics information to be transmitted (step 780). If these types of information are not designated, the communication history transmission unit 724 uses default values, as mentioned above. The communication history transmission unit 724 reads a record corresponding to the information that is thus obtained from the transmission request, from the communication history statistics information storage unit 722 (step 782).

If the received transmission request includes specific communication device information, communication line information, or telecommunications carrier information, the communication history transmission unit 724, when reading information from the communication history statistics information DB 702, extracts only the records (communication environment information) that contain communication device information, communication line information, and telecommunications carrier information that matches the included information. The communication history transmission unit 724 also performs statistics processing on values related to the communication quality metrics of those records to calculate representative statistical values.

The communication history transmission unit 724 shapes the information included in the read records or the information that has been subjected to statistics processing into a predetermined format, and transmits the resulting information to the communication history acquisition unit 160 of the in-vehicle device 652 in one or more packets (step 784).

The communication history acquisition unit 160 receives this statistics information from the communication history transmission unit 724 and adds it to the communication history statistics information DB 702 in FIG. 17. The added information is input from the communication history statistics information DB 702 to the route calculation unit 704. The route calculation unit 704 calculates a route from the current position to the destination in accordance with the designated conditions using the thus-obtained statistics information regarding the communication history.

The operation of the other units are the same as those of the in-vehicle devices in the first to third embodiments.

### C. Variations

In the fourth embodiment, statistics metrics based on the communication environment such communication devices, communication lines, or telecommunications carriers, are not calculated. This is because there are inherently many types of communication environments, and they often change, making them unsuitable for continuous statistics calculations. There is also a problem that, if the communication history information is subdivided using these types of information, the amount of calculation for statistics processing increases. However, if, for example, the in-vehicle device 652 uses a specific communication device, communication line, or telecommunications carrier, it is considered that the estimation of the communication status will be more reliable when using statistics metrics that take it into account.

Thus, in this variation, the communication history management server normally operates in the same manner as in the fourth embodiment. However, if the transmission request includes information related to the communication environment, the communication history management server extracts only the records that match the designated conditions from a detailed list of the communication history information stored in the communication history information storage unit 202, rather than the statistics information stored in the communication history statistics information storage unit 722. Statistics processing is performed on the read records, and the results are transmitted to the in-vehicle device.

FIG. 22 is a block diagram showing a communication history management server 790 in this variation. The communication history management server 790 is different from the communication history management server 658 shown in FIG. 18 in that the communication history management server 790 includes a communication history transmission unit 792 that receives a transmission request and performs different processing depending on whether or not the transmission request includes information related to the communication environment, in place of the communication history transmission unit 724 shown in FIG. 18. The communication history transmission unit 792 normally reads information from the communication history statistics information storage unit 722 and transmits the read information to the in-vehicle device, similarly to the communication history transmission unit 724 in the fourth embodiment. However, if the transmission request includes information related to the communication environment (e.g., a communication line or a telecommunications carrier, or a combination thereof), the communication history transmission unit 792 performs different processing.

The communication history management server 790 further includes an aperiodic communication statistics processing calculation unit 794 that, when the transmission request includes information related to the communication environment, reads records including the designated date and time and range, and communication environment information that matches the information related to the communication environment from the communication history information storage unit 202 in response to an instruction from the communication history transmission unit 792, and performs statistics processing related to communication quality metrics on the read records and returning the results to the communication history transmission unit 792.

That is, when the transmission request includes the information related to the communication environment, the communication history transmission unit 792 obtains information from the aperiodic communication statistics processing calculation unit 794, rather than from the communication history statistics information storage unit 722

With this configuration, the communication history management server 790 according to this variation can normally transmit communication quality metrics to the in-vehicle device at high speed using information in the communication history statistics information storage unit 722. In addition, when the transmission request includes information specifying the communication environment, the communication history management server 790 can transmit communication quality metrics obtained only from the communication history that matches the specified communication environment to the in-vehicle device. As a result, the accuracy of the statistics quality metrics transmitted to the in-vehicle device can be improved while preventing an increase in the load of statistics processing.

### 5. FIFTH EMBODIMENT

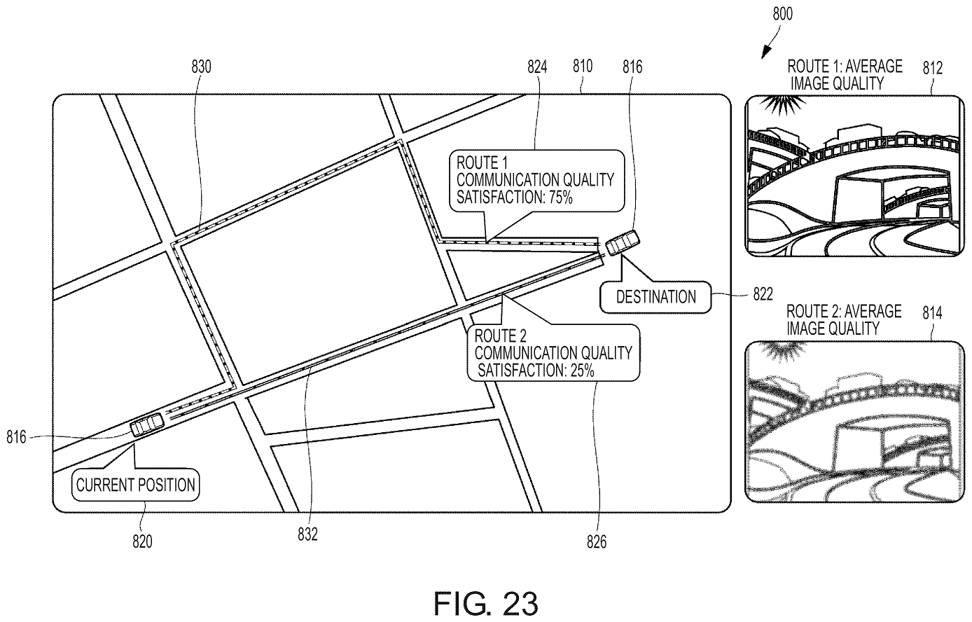

The fifth embodiment is characterized in the display mode when the travel routes are suggested. The configuration of the in-vehicle device for this display mode is the same as that of the in-vehicle device 102 shown in FIG. 3, for example. However, in this embodiment, a grid is not superimposed on the map as performed by the grid rendering unit 166 shown in FIG. 3. Instead, in the fifth embodiment, a suggested route display unit (not shown) is used that displays suggested travel routes in different modes depending on the communication speed expected to be available in each block through which each suggested travel route passes, as shown in FIG. 23.

Referring to FIG. 23, in the fifth embodiment, a display 800 of the touchscreen display device 116 includes a travel route display 810, a first route prediction image display 812, and a second route prediction image display 814.

A map is displayed in the travel route display 810, and the current position and the destination of a vehicle image 816 are displayed as balloons 820 and 822 superimposed on the map. A grid (blocks) is not displayed. Instead, each portion of the images of the travel routes 830 and 832 is displayed with a hue and brightness corresponding to the communication speed in a block to which the portion belongs. Typically, the hue is red, and the brightness is adjusted in accordance with a monotonic function of the communication speed such that the brightness increases as the communication speed increases, and decreases as the communication speed decreases. Note that, in FIG. 23, such changes in the display mode are not shown due to the restrictions on the drawings.

In the fifth embodiment, representative values of the communication speed (e.g., the average bit rate, the proportion of the route length where the minimum bit rate designated by the service can be used to the entire route length, etc.) is displayed for each travel route, in association therewith. The examples thereof include “communication quality satisfaction” shown in balloons 824 and 826 in FIG. 23. For example, according to the balloon 824, the communication quality satisfaction in the first route (first travel route) is 75%. This means that the sum of the route lengths of the portions where the bit rate designated by the service can be maintained in the first travel route corresponds to 75% of the total length of the first travel route. In the second travel route, this value is 25%. That is, on the first travel route, the service can be used with the expected highest quality for three-fourths of the total length, while in the second travel route, it can be used for only one-fourth of the total length. Displaying such a representative value has the effect of allowing the user to easily understand the communication quality on each route.

The first route prediction image display 812 and the second route prediction image display 814 each represent, in the form of an image, predicted image quality of images displayed on the respective travel routes in the case where the service used during travel along the travel routes is video streaming. In this example, a sample image is prepared in advance. The predicted image quality is represented by an image with a reduced number of pixels of the sample image in accordance with the proportion of the representative value of the predicted communication speed during travel along each travel route to the communication speed that allows the image to be received with its original resolution. As mentioned above, representing the communication quality on each route with a numerical value allows the user to understand the difference, but it is difficult to grasp the difference intuitively. However, as indicated by the first route prediction image display 812 and the second route prediction image display 814, representing the communication quality on each travel route as a difference in the image has the effect of allowing the user to easily and intuitively grasp the difference in the communication quality. Although balloons are used in this example, the display of each travel route and communication quality may be associated with each other by displaying, for example, a line connecting the display of the communication quality and the corresponding travel route, instead of a balloon.

It is desirable to present such an effect to the user in accordance with the type of service. For example, if the service the user wants to use is an audio-related service rather than a video-related service, it is conceivable to superimpose noise corresponding to the communication speed on sample audio or sample music instead of a sample image.

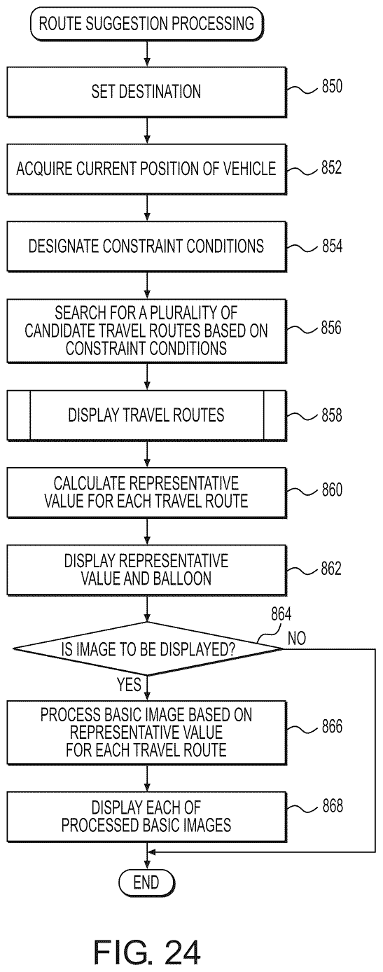

FIG. 24 shows a control structure of a computer program that implements the above-described route suggestion processing unit regarding the fifth embodiment. Referring to FIG. 24, the program includes step 850 of setting a destination, step 852 of acquiring the current position of the vehicle, and step 854 of receiving from the user the designation of constraint conditions for calculating routes.

This program further includes: step 856 of searching for a travel route from the current position to the destination designated in steps 850 and 852 under the constraint conditions designated in step 854; step 858 of displaying each of the travel routes searched in step 856, as shown in the travel route display 810 in FIG. 23; step 860 of calculating a representative value representing the communication quality for each of the travel routes; and step 862 of displaying, for each of the travel routes, the representative value calculated in step 860 together with the balloons 824 and 826 each having a protrusion in contact with the corresponding travel route.

The program further includes: step 864 of determining whether or not to display an image for representing the communication quality as in the case where the service is related to video, and branching the flow of control in accordance with the determination result, and includes, when the determination result in step 864 is positive: step 866 of processing the sample image prepared in advance based on the representative value calculated in step 860 for each travel route; and step 868 of displaying the sample image processed in step 866 at a predetermined position relative to the travel route display 810, as shown by the first route prediction image display 812 and the second route prediction image display 814 in FIG. 23, and ending the execution of this program. If it is determined in step 864 that the image display is not necessary, steps 866 and 868 are not executed.

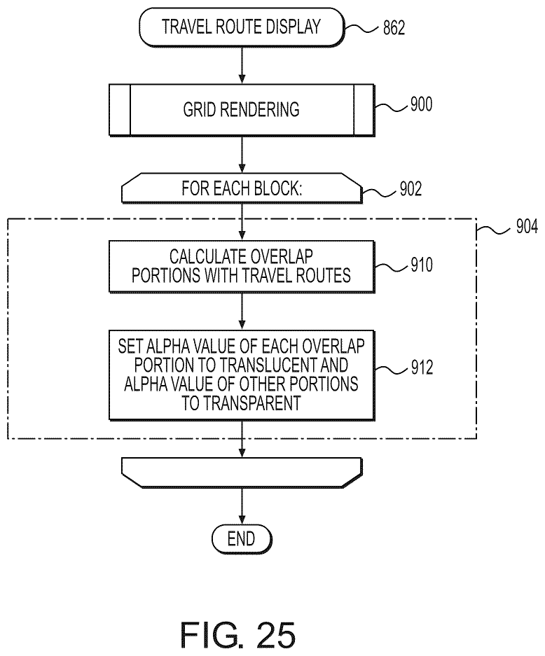

Referring to FIG. 25, step 858 in FIG. 24 includes step 900 of performing the same grid rendering processing as shown in FIG. 9, and step 902 of executing step 904 on each of the blocks in the grid obtained in step 900.
Step 904 includes step 910 of calculating overlap portions of the blocks to be processed and each travel route, and step 912 of, regarding each overlap portion calculated in step 910, setting the alpha value of each pixel so as to display the overlap portions translucent and the other portions transparent, and ending step 904.

With this processing, blocks in the grid that do not have a portion overlapping with the travel routes are displayed transparent. That is, the map is displayed as it is. As for blocks in the grid that have a portion overlapping with the travel routes, the overlap portion is displayed with the hue and brightness set by the processing in step 900, while the other portions are displayed transparent. As a result, portions of each travel route are displayed in different modes (hues and brightnesses) in accordance with the communication quality (communication speed) at the respective portions. The map is displayed at portions other than the travel route. That is, a display such as shown by the travel route display 810 in FIG. 23 is obtained.

As described above, according to the fifth embodiment as well, the communication quality on the suggested travel routes is visually displayed, and the user can select a travel route considered to be optimal in accordance with the service to be used and the time required to reach the destination.

### 6. IMPLEMENTATION BY COMPUTER

### A) Hardware of In-Vehicle Device

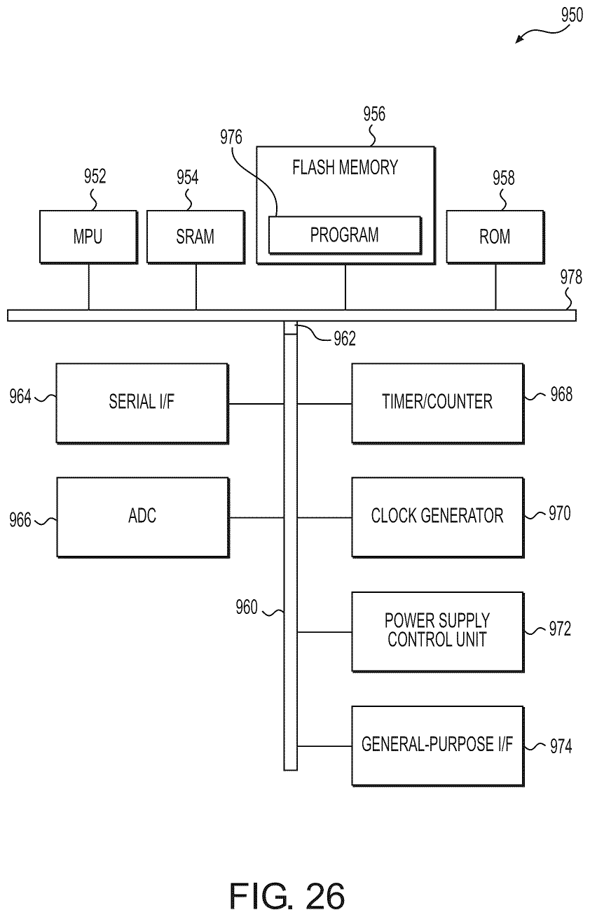

The in-vehicle device according to the present disclosure, such as the in-vehicle device shown in FIG. 2 or other figures, includes a communication device and an MCU (Micro Controller Unit) including a storage device storing a program to be executed by the MCU. All components of the MCU are hardware. FIG. 26 shows a configuration of the MCU 950 in a block form.

Referring to FIG. 26, the MCU 950 includes an MPU 952, which is a processor, a high-speed bus 978 to which the MPU 952 is connected, an SRAM 954 connected to the high-speed bus 978, a flash memory 956 connected to the high-speed bus 978, and a ROM 958 connected to the high-speed bus 978. The SRAM 954 holds data necessary for executing programs, for example. The flash memory 956 stores a program 976 for implementing each function of the in-vehicle device according to the first to fifth embodiments. The ROM 958 stores, for example, a boot-up program for the MPU 952.

The MCU 950 further includes a low-speed bus 960 connected to the high-speed bus 978 via a bridge 962, as well as a serial I/F 964, an ADC 966, a timer/counter 968, a clock generator 970, a power supply control unit 972, and a general-purpose I/F 974, which are connected to the low-speed bus 960.

Since the operation of the MCU is well known and it is the function of the program executed thereby that is meaningful in the embodiments, the description of the operation of the MCU itself is not repeated in the following description.

### B) Hardware of Server

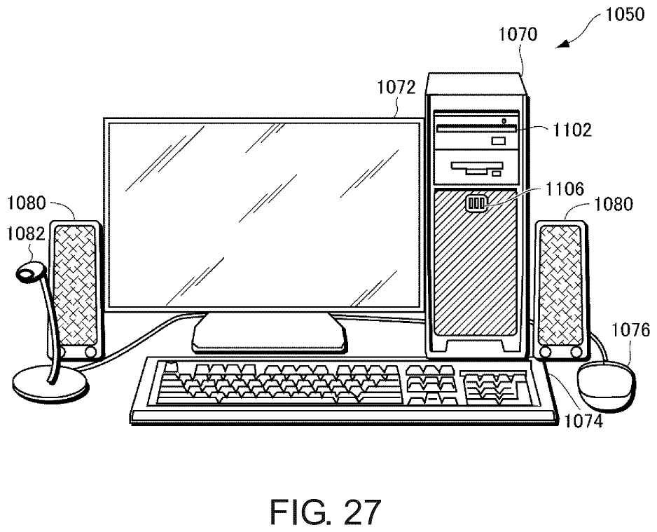

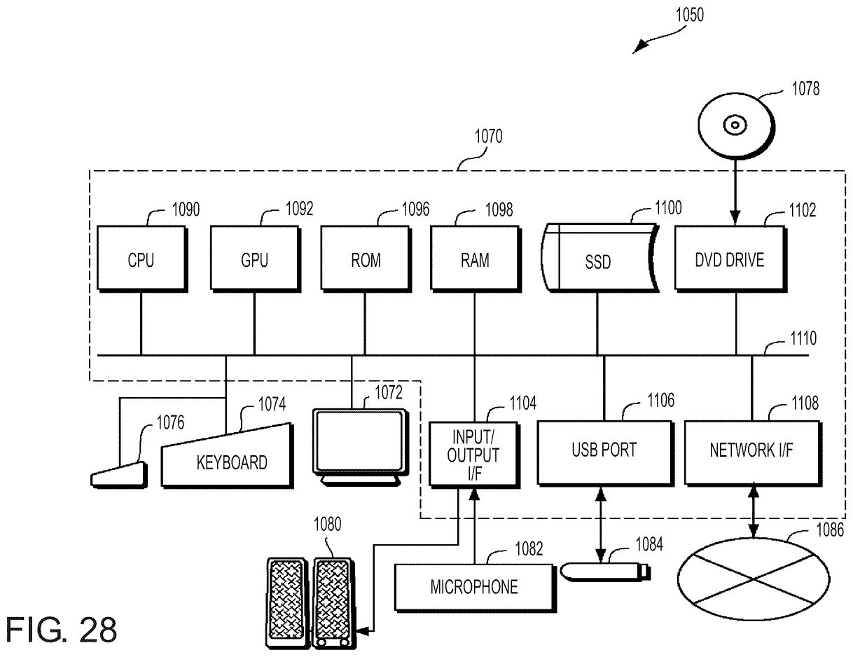

FIG. 27 is an appearance view of an example of a computer system that implements the communication history management servers 110 and 408, the communication history management server 658, and the like according to the above-described embodiments. FIG. 28 is a block diagram showing an example of a hardware configuration of the computer system shown in FIG. 27.

Referring to FIG. 27, a computer system 1050 includes a computer 1070 to which a DVD drive 1102 is connected, as well as a keyboard 1074, a mouse 1076, and a monitor 1072, which are connected to the computer 1070 for interacting with the user. This is an example of the configuration when user interaction is required, and any type of general hardware and software available for user interaction (e.g., a touch panel, audio input, and pointing device in general) can be used.

Referring to FIG. 28, the computer 1070 includes: a CPU 1090; a GPU 1092; a bus 1110 connected to the CPU 1090, the GPU 1092, and the DVD drive 1102; a ROM 1096 connected to the bus 1110 and storing a boot-up program and the like for the computer 1070; a RAM 1098 connected to the bus 1110 and storing instructions constituting programs, system programs, work data, and the like; and an SSD 1100 that is a non-volatile memory connected to the bus 1110. The SSD 1100 stores programs executed by the CPU 1090 and the GPU 1092, data used by the programs executed by the CPU 1090 and the GPU 1092, and the like. The computer 1070 further includes: a network I/F 1108 that provides connection to a network 1086 that allows communication with other terminals; and a USB port 1106 to and from which a USB memory 1084 can be attached and detached and that provides communication between the USB memory 1084 and each portion in the computer 1070.

The computer 1070 further includes an input/output I/F 1104 connected to external devices, such as a microphone 1082 and a speaker 1080, and to the bus 1110, and configured to read audio signals, video signals, and text data generated by the CPU 1090 and stored in the RAM 1098 or SSD 1100 in accordance with instructions from the CPU 1090, drive the speaker 1080 by performing analogue conversion and amplification processing, and digitalize an analog audio signal from the microphone 1082 to store it at any address in the RAM 1098 or SSD 1100 designated by the CPU 1090.

Programs, parameters, sample images used in the fifth embodiment, and the like for implementing the communication history management servers 110, 408, 658, and the like in the above embodiments are all stored, for example, in the SSD 1100, the RAM 1098, a DVD 1078 or the USB memory 1084, or a storage medium on an external device (not shown) connected via the network I/F 1108 and the network 1086 shown in FIG. 28. Typically, these data, parameters, and the like are written, for example, from an external device to the SSD 1100 and loaded into the RAM 1098 when executed by the computer 1070.

A program that cooperates with the computer 1070 to implement the functions of each part according to the above-described embodiments includes a plurality of instructions that are described and arranged to cause the computer 1070 to implement these functions. Some of the basic functions required to execute these instructions are provided by an operating system (OS) or a third-party program running on the computer 1070, or by modules in various toolkits installed on the computer 1070. Accordingly, this program need not necessarily include all the functions required to implement the systems and methods of these embodiments. The program need only contain instructions to perform the operations of each of the above-described devices and components thereof, either by statically linking appropriate functions or functions of a “programming tool kit” in a controlled manner so as to produce desired results, or by dynamically linking to those functions when the program is executed, in the instructions. Since the method of operating the computer 1070 for that purpose is well known, it is not repeated here.

Note that the GPU 1092 is capable of parallel processing, and can execute a large amount of calculations, such as those involved in route search processing and statistics processing, simultaneously in parallel or in a pipelined manner. For example, parallel computational elements discovered in a program when the program is compiled, or parallel computational elements discovered when the program is executed, are dispatched from the CPU 1090 to the GPU 1092 at any time and executed, and the results are returned to the CPU 1090 directly or via a predetermined address in the RAM 1098 and substituted to a predetermined variable in the program.

Note that the embodiments disclosed herein are in all respects illustrative and should not be considered restrictive. The scope of the present disclosure is not defined by the detailed description of the disclosure but by the claims, and is intended to include all changes made within the meaning and scope equivalent to the language of the claims.

1. A communication history management server comprising:
a processor that is configured to:
receive communication history information including at least position information, date and time information, and communication quality metrics information related to at least communication quality of wireless communication at a position specified by the position information and at a date and time specified by the date and time information;
accumulate in a memory the communication history information that is received; and
in response to receiving a transmission request to transmit the communication history information with a regional range designated from an external device, generate information related to communication history including the position information corresponding to an inside of the regional range designated by the transmission request and communication quality information obtained from the communication quality metrics information, based on the communication history information accumulated in the memory, and transmit the generated information to the external device.

2. The communication history management server according to claim 1, wherein:
the processor is configured to read the communication history information accumulated in the memory and transmit the communication history information read to the external device, and
the communication history information read includes:
the position information corresponding to an inside of the regional range designated by the transmission request;
the date and time information within a most recent predetermined time; and
the communication quality metrics information.

3. The communication history management server according to claim 1, wherein:
each piece of the communication history information further includes communication environment information related to a communication environment when wireless communication related to the piece of the communication history information is performed,
the transmission request further includes information related to a communication environment of the external device, and
the processor is configured to, in response to receiving the transmission request, read the communication history information accumulated in the memory and transmit the communication history information read to the external device,
the communication history information read includes:
the position information corresponding to an inside of the regional range designated by the transmission request;
the communication environment information matching the information related to the communication environment included in the transmission request; and
the communication quality metrics information.

4. The communication history management server according to claim 3, wherein the communication environment information includes communication line information, telecommunications carrier information, or a combination thereof.

5. The communication history management server according to claim 1, wherein:
the processor is configured to:
calculate communication history statistics information by performing statistics processing related to the communication quality metrics information on the communication history information accumulated in the memory, based at least on the position specified by the position information;
store in the memory the communication history statistics information calculated in association with the position information,
in response to receiving a transmission request to transmit the communication history information with a regional range designated from an external device, transmit to the external device, the position information corresponding to an inside of the regional range designated by the transmission request and the communication history statistics information regarding a position specified by the position information, out of the communication history statistics information stored in the memory.

6. The communication history management server according to claim 5,
wherein the processor is configured to calculate per-period communication history statistics information by performing statistics processing related to the communication quality metrics information on the communication history information accumulated in the memory, based at least on the position specified by the position information and a period specified by the date and time information.

7. The communication history management server according to claim 6, wherein:
each piece of the communication history information further includes information related to a communication environment when wireless communication related to the piece of the communication history information is performed,
the transmission request can include information related to the communication environment of the external device,
the processor is configured to selectively execute first processing and second processing in accordance with whether or not the received transmission request includes the information related to the communication environment,
the first processing is processing for reading, from the communication history statistics information stored in the memory, the communication history statistics information matching the position information corresponding to an inside of the regional range designated by the transmission request and the information related to the communication environment included in the transmission request, calculating the communication quality metrics information based on the read communication history statistics information, and transmitting the calculated communication quality metrics information to the external device, and
the second processing is processing for reading the communication history information corresponding to the position information corresponding to an inside of the regional range designated by the transmission request from the communication history information accumulated in the memory and transmitting the read communication history information to the external device.

8. A communication history management method comprising:
receiving communication history information including at least position information, date and time information, and communication quality metrics information related to at least communication quality of wireless communication at a position specified by the position information and at a date and time specified by the date and time information, with use of a processor;
accumulating, in a memory, the communication history information received with use of the processor; and
in response to receiving a transmission request to transmit the communication history information with a regional range designated from an external device, generating information related to communication history including the position information corresponding to an inside of the regional range designated by the transmission request and communication quality information obtained from the communication quality metrics information, based on the communication history information accumulated in the memory, and transmitting the generated information to the external device, with use of the processor.

9. A storage medium that stores a computer program that causes a processor to:
receive communication history information including at least position information, date and time information, and communication quality metrics information related to at least communication quality of wireless communication at a position specified by the position information and at a date and time specified by the date and time information;
accumulate, in a memory, the communication history information received; and
in response to receiving a transmission request to transmit the communication history information with a regional range designated from an external device, generate information related to communication history including the position information corresponding to an inside of the regional range designated by the transmission request and communication quality information obtained from the communication quality metrics information, based on the communication history information accumulated in the memory, and transmit the generated information to the external device.
